(19) United States
(12) Patent Application Publication
(10) Pub. No.: US 2026/0017100 A1
(43) Pub. Date: Jan. 15, 2026

(54) Designating Memory Regions For Instantiating Objects In Accordance With Memory Allocation Constraints

(71) Applicant: Oracle International Corporation, Redwood Shores, CA (US)

(72) Inventor: Erik Österlund, Vasterhaninge (SE)

(73) Assignee: Oracle International Corporation, Redwood Shores, CA (US)

(21) Appl. No.: 18/770,066

(22) Filed: Jul. 11, 2024

(51) Int. Cl. G06F 9/50

(52) U.S. Cl. CPC G06F 9/5016; G06F 9/5033

(57) ABSTRACT

A system defines memory allocation constraints for calls from various caller methods to various target methods and then executes a process for configuring a memory allocation bitmask for designating memory regions for instantiating objects in accordance with the memory allocation constraints. The memory allocation constraints require different target methods to utilize different memory regions from one another for instantiating objects in response to calls from various caller methods. The process for configuring the memory allocation bitmask includes determining, based on the memory allocation constraints, that calls from a particular caller method to a particular target method do not require utilization of different memory regions for instantiating objects. Additionally, the process includes designating a memory allocation bit position of the memory allocation bitmask for indicating a memory region to be utilized for instantiating objects in response to the calls from the particular caller method to the particular target method.

### TECHNICAL FIELD

The present disclosure relates to designating memory regions for instantiating objects. More particularly, the present disclosure relates to determining whether to instantiate objects in shared memory regions or private memory regions, including to facilitate garbage collection processes for reclaiming memory from private memory regions.

### BACKGROUND

Computing systems, such as virtual machines, utilize various memory management techniques to optimize performance. Memory management techniques enhance performance, particularly for computing systems that execute multiple threads with frequent memory allocation and deallocation operations. Memory allocations can be generally categorized into thread-local memory regions and shared memory regions. Thread-local memory regions are referred to as private memory regions because they are allocated for use by a particular thread and are generally not intended for use by other threads. Shared memory regions are allocated for use by multiple threads.

When a computing system instantiates objects, the computing system determines whether the objects should be instantiated in a private memory region or a shared memory region. Objects that are specific to a particular thread and that are not intended to be accessed by other threads are typically instantiated in a private memory region that is allocated for use by the particular thread. Objects that are accessed by multiple threads are typically instantiated in a shared memory region. The computing system may allocate multiple private memory regions for use by various particular threads. The computing system may allocate one or more shared memory regions for use by multiple threads.

The distinction between private memory regions and shared memory regions enhances the efficiency of garbage collection processes that reclaim memory occupied by objects that are no longer being utilized. For example, the distinction between private memory regions and shared memory regions allows garbage collection processes to focus on reclaiming memory from particular memory regions. In one example, thread-local garbage collection processes reclaim memory from private memory regions, and global garbage collection processes reclaim memory from shared memory regions.

Because private memory regions are allocated for use by a particular thread, thread-local garbage collection processes can quickly identify and reclaim memory occupied by objects in private memory that are no longer being utilized without the need for complex synchronization mechanisms that are typically employed by global garbage collection processes that reclaim memory from shared memory regions. This reduces contention and overhead, leading to faster and more efficient garbage collection cycles. By segregating memory allocation between private memory and shared memory, computing systems can utilize multiple garbage collection processes that employ techniques for reclaiming thread-local memory or shared memory, thereby improving memory utilization and system performance for thread-local and shared memory scenarios.

The content of this background section should not be construed as prior art merely by virtue of its presence in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 is a block diagram that depicts an example computing architecture for implementing features described herein in accordance with one or more embodiments;

FIG. 2 is a block diagram that depicts an example computer system for implementing features described herein in accordance with one or more embodiments;

FIG. 3 is a block diagram that depicts an example virtual machine memory layout according to one or more embodiments;

FIG. 4 is a block diagram that depicts an example frame according to one or more embodiments;

FIG. 5A is a block diagram that depicts an example call stack according to one or more embodiments;

FIG. 5B is a block diagram that depicts an example set of callers of a call stack and an example set of targets of the call stack that can be reached by various callers according to one or more embodiments;

FIGS. 5C-5F are block diagrams that depict example calling relationships between callers and targets of a call stack and example memory allocation constraints determined based on the calling relationships according to one or more embodiments;

FIG. 5G is a block diagram that depicts example bit positions, determined based on memory allocation constraints, for use in determining memory regions for instantiating objects in response to calls from callers to targets according to one or more embodiments;

FIGS. 6A-6C are tables that depict examples of target bitmasks, caller bitmasks, and memory allocation bitmasks, respectively, for use in determining memory regions for instantiating objects in accordance with memory allocation constraints according to one or more embodiments;

FIG. 7A is a flowchart that depicts example operations pertaining to determining memory regions for instantiating objects in accordance with memory allocation constraints in accordance with one or more embodiments;

FIG. 7B is a flowchart that depicts example operations pertaining to determining constraint inputs for defining memory allocation constraints that are utilized for determining memory regions for instantiating objects;

FIG. 7C is a flowchart that depicts example operations pertaining to defining, for a set of calling relationships, memory allocation constraints that are utilized for determining memory regions for instantiating objects;

FIG. 7D is a flowchart that depicts example operations pertaining to configuring memory allocation bitmasks for use in determining memory regions for instantiating objects in accordance with memory allocation constraints;

FIG. 7E is a flowchart that depicts example operations pertaining to assigning, based on a set of memory allocation constraints, a set of target bit positions to a set of target bitmasks associated with a set of targets;

FIG. 7F is a flowchart that depicts example operations pertaining to assigning, based on a set of target bitmasks, a set of caller bit positions to a set of caller bitmasks associated with a set of callers;

FIG. 7G is a flowchart that depicts example operations pertaining to determining memory regions for instantiating objects; and

FIG. 8 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. DEFINITIONS
3. ARCHITECTURAL OVERVIEW
   3.1 EXAMPLE CLASS FILE STRUCTURE
   3.2 EXAMPLE VIRTUAL MACHINE ARCHITECTURE
   3.3 LOADING, LINKING, AND INITIALIZING
4. EXAMPLE MEMORY ALLOCATION CONSTRAINTS DETERMINED FROM CALLING RELATIONSHIPS IN A CALL STACK
   4.1 EXAMPLE CALL STACKS
   4.2 EXAMPLE CALLING RELATIONSHIPS
   4.3 EXAMPLE MEMORY ALLOCATION CONSTRAINTS
5. EXAMPLE BITMASKS FOR USE IN DETERMINING MEMORY REGIONS FOR INSTANTIATING OBJECTS
6. EXAMPLE OPERATIONS PERTAINING TO DETERMINING MEMORY REGIONS FOR INSTANTIATING OBJECTS IN ACCORDANCE WITH MEMORY ALLOCATION CONSTRAINTS
   6.1 DETERMINING CONSTRAINT INPUTS FOR DEFINING MEMORY ALLOCATION CONSTRAINTS
   6.2 DEFINING MEMORY ALLOCATION CONSTRAINTS FOR CALLING RELATIONSHIPS
   6.3 CONFIGURING BITMASKS FOR USE IN DESIGNATING MEMORY REGIONS FOR INSTANTIATING OBJECTS
   6.4 UTILIZING BITMASKS TO DESIGNATE MEMORY REGIONS FOR INSTANTIATING OBJECTS
7. EXAMPLE EMBODIMENTS
   7.1. UTILIZING THE SAME BIT POSITION OF A MEMORY ALLOCATION BITMASK FOR DIFFERENT CALLING RELATIONSHIPS
   7.2. UTILIZING DIFFERENT BIT POSITIONS OF A MEMORY ALLOCATION BITMASK FOR DIFFERENT CALLING RELATIONSHIPS
   7.3. MEMORY ALLOCATION CONSTRAINTS BASED ON ALLOCATION SITES EXECUTED BY TARGET METHODS
   7.4. MEMORY ALLOCATION CONSTRAINTS BASED ON CALLER SITES THAT CALL TARGET METHODS
   7.5. MEMORY ALLOCATION CONSTRAINTS BASED ON ALLOCATION SITES EXECUTED BY TARGET METHODS IN RESPONSE TO CALLS FROM CALLER SITES OF CALLER METHODS
8. HARDWARE OVERVIEW
9. MISCELLANEOUS; EXTENSIONS

### 1. General Overview

A system defines memory allocation constraints for calling relationships between caller methods and target methods that require objects instantiated by target methods of different calling relationships to be instantiated in different memory regions. In one example, the memory allocation constraints require a target method to instantiate objects in a shared memory region in response to calls from one or more caller methods that have a shared object-generating relationship with the target method. Additionally, or alternatively, the memory allocation constraints may allow a target method to instantiate objects in a private memory region, such as a thread-local memory region, in response to calls from one or more caller methods that have a private object-generating relationship with the target.

The system determines a set of constraint inputs for defining the memory allocation constraints. The constraint inputs indicate whether various calling relationships are shared object-generating relationships or private object-generating relationships. The system determines whether a calling relationship is a shared object-generating relationship or a private object-generating relationship by static and/or dynamic analysis of calling relationships. The system designates calling relationships that are capable of triggering instantiation of shared objects as shared object-generating relationships. The system designates calling relationships that have yet to trigger instantiation of a shared object as private object-generating relationships. Based on the constraint inputs, the system defines memory allocation constraints that provide for target methods to utilize different memory regions for instantiating objects as between calls from shared object-generating relationship and calls from private object-generating relationships. In one example, a memory allocation constraint provides for a target method to utilize a shared memory region to instantiate objects in response to calls from a caller method that has a shared object-generating relationship with the target method. Target methods that are unconstrained by the memory allocation constraints may utilize a private object memory region to instantiate objects. Additionally, or alternatively, the system may define a memory allocation constraint that provides for a target method to utilize a private memory region to instantiate objects in response to calls from a caller method that has a private object-generating relationship with the target method.

The system executes a process for configuring a memory allocation bitmask for use in determine memory regions for instantiating objects in accordance with the memory allocation constraints. In one example, the process for configuring the memory allocation bitmask includes assigning target bit positions to target bitmasks associated with target methods. The system may utilize a graph coloring algorithm to assign the target bit positions to the target bitmasks. The system may assign the same bit position to a set of target methods that are not linked to one another by a memory allocation constraint. The system assigns different bit positions to a set of target methods that are linked to one another by a memory allocation constraint. Additionally, the process includes assigning a set of caller bit positions to a set of caller bitmasks associated with the asset of caller methods. One or more caller bit positions of a caller bitmask associated with a caller method are bitwise complements of one or more target bit positions of one or more target bitmasks corresponding to one or more target methods that have a calling relationship with the caller. The system stores the caller bitmasks for populating the memory allocation bitmask with the particular caller bitmask that corresponds to a caller method that initiates a call to a target method. The system stores the target bitmasks for comparing the particular target bitmask corresponding to the target method with the memory allocation bitmask as populated by the caller bitmask.

In one example, when a caller method initiates a call to a target method that triggers the target method to instantiate an object, the system populates the memory allocation bitmask with the caller bitmask corresponding to the caller method. Additionally, the system executes a comparison of the memory allocation bitmask, as populated by the caller bitmask, to the caller bitmask corresponding to the target method. In one example, the comparison includes executing a bitwise operation, such as a bitwise AND operation, on the memory allocation bitmask and the target bitmask to obtain a bitwise result. When the system determines that the bitwise result is non-zero, the system designates a shared memory region for the target method to instantiate the object. When the system determines that the bitwise result is zero, the system designates a private memory region for the target method to instantiate the object. Upon having designated a memory region for instantiating the object, the target method instantiates the object in the designated memory region. Subsequently, the system may execute one or more garbage collection process to reclaim memory that is occupied by objects that are no longer being utilized. The system may utilize a thread-local garbage collection process to reclaim memory from one or more private memory regions. The system may utilize a global garbage collection process to reclaim memory from one or more shared memory regions.

One or more embodiments described in this Specification and/or recited in the claims may not be included in this General Overview section.

### 2. Definitions

As used herein, the term “caller method” refers to a method that initiates a call to a target method. A caller method may include code that makes a method call. A caller method may pass arguments to the target method and may receive return value from the target method. In one example, a caller method passes an argument to the target method that includes an instruction for the target method to instantiate an object. In one example, a caller method passes an argument to the target method that causes the target method to execute operations that include instantiating an object.

As used herein, the term “call site” refers to a location in a set of code of a caller method where a call to a target method is executed. For an inlined caller method, a call site may refer to code that a represents a target method that has been added to a caller method.

As used herein, the term “caller” refers to a caller method or a call site of a caller method.

As used herein, the term “target method” refers to a method that is called by a caller method. A target method is located at a separation portion of code from a caller method. A target method may include code and contains the logic that is executed in response to a call from a caller method such as in response to an argument passed from the caller method to the target method. The target method can return a value to the caller, for example, in response to the call. In one example, a target method instantiates an object in a memory region and returns a pointer or a reference to the caller method that points to a location of the object in the memory region.

As used herein, the term “allocation site” refers to a location in a set of code of a target method where an object is instantiated in a memory region.

As used herein, the term “target” refers to a target method or an allocation site of a target method.

As used herein, the term “inlined caller method” refers to a caller method that includes code that represents one or more target methods that have been added to the caller method.

As used herein, the term “calling relationship” refers to a relationship between a caller that can initiate one or more calls to a target and the target that receives the one or more calls from the caller. A calling relationship may refer to a relationship between a caller method and a target method, a relationship between a call site and a target method, a relationship between a caller method and an allocation site of a target method, or a relationship between a call site and an allocation site. A calling relationship may be a shared object-generating relationship or a private object-generating relationship.

As used herein, the term “shared object-generating relationship” refers to a calling relationship that has been determined to be capable of triggering a target of the calling relationship to instantiate a shared object. A calling relationship may be determined to be capable of triggering a target of the calling relationship to instantiate a shared object based on a static or dynamic analysis.

As used herein, the term “private object-generating relationship” refers to a calling relationship that has yet to trigger a target of the calling relationship to instantiate a shared object. In one example, a system considers calling relationships to be private object-generating relationships unless and/or until the system determines that the calling relationship is a shared object-generating relationship, for example, based on a static or dynamic analysis.

As used herein, the term “calling relationship junction” refers to a caller or a target that belongs to multiple calling relationships. In one example, multiple calling relationships may share a caller that defines a calling relationship junction. In one example, multiple calling relationships may share a target that defines a calling relationship junction.

As used herein, the term “calling family” refers to a set of one or more callers and a set of one or more targets that belong to calling relationships that are linked to one another by a set of one or more calling relationship junctions. A calling family may include a caller and a set of targets that have calling relationships with the caller. Additionally, or alternatively, a calling family may include a target and a set of callers that have a calling relationship with the target.

As used herein, the term “call” refers to the act of invoking or executing a method. A call may include a caller transferring control from a current point in a set of code to a target, where the target performs one or more specified operations, for example, according to defined logic and parameters. After the target performs the one or more specified operations, control typically returns to the caller at the point in the set of code immediately following the call.

As used herein, the term “memory region” refers to a contiguous block or segment of memory that is designated for specific purposes and/or managed under specific constraints.

As used herein, the term “memory allocation constraint” refers to a constraint that provides for different memory regions to be utilized for instantiating objects instantiated by targets of different calling relationships. A memory allocation constraint may provide for utilizing different memory regions for instantiating objects as between objects instantiated by a target of a shared object-generating relationship and objects instantiated by a target of a private object-generating relationship. A memory allocation constraint may provide for a target of a shared object-generating relationship to utilize a shared memory region for instantiating objects. Additionally, or alternatively, a memory allocation constraint may provide for a target of a private object-generating relationship to utilize a private memory region for instantiating objects.

As used herein, the term “constraint input” refers to information utilized to determine one or more memory allocation constraints. A constraint input may include an indication that a calling relationship between a caller and a target is a shared object-generating relationship or a private object-generating relationship.

As used herein, the term “object” refers to an instance of a class that defines a structure and behavior through a set of attributes and/or methods. An object may encapsulate data through attributes that store information about a state of the object. The attributes can include variables that hold values specific to the instance of the class. An object may include a method that defines operations the object can perform. The method of an object may manipulate data of the object and/or perform operations related to the object.

As used herein, the term “class” refers to a template that defines attributes and behaviors of a particular type of object. A class serves as a template that can be utilized to instantiate objects.

As used herein, the term “shared object” refers to an object that can be accessed and/or modified by multiple components or threads of a system.

As used herein, the term “private object” refers to an object that can be accessed and/or modified by a particular portion of a system, such as a particular thread, module, or class.

### 3. Architectural Overview

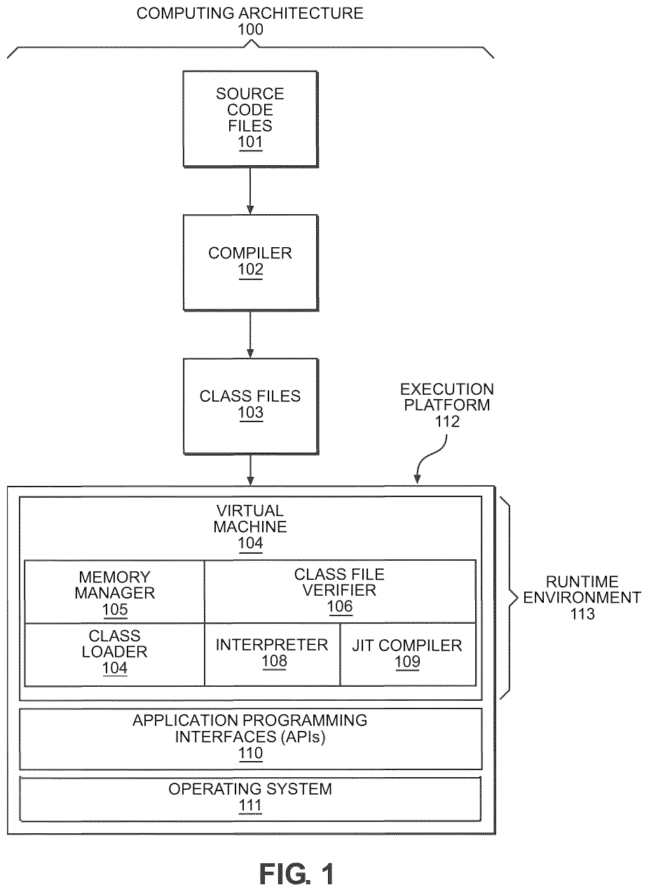

FIG. 1 illustrates an example architecture according one or more embodiments. Software and/or hardware components described with relation to the example architecture may be omitted or associated with a different set of functionalities than described herein. Software and/or hardware components, not described herein, may be used within an environment in accordance with one or more embodiments. Accordingly, the example environment should not be constructed as limiting the scope of any of the claims.

As illustrated in FIG. 1, a computing architecture 100 includes source code files 101 that are compiled by a compiler 102 into class files 103 representing the program to be executed. The class files 103 are then loaded and executed by an execution platform 112. The execution platform 112 includes a runtime environment 113, an operating system 111, and one or more application programming interfaces (APIs) 110 that enable communication between the runtime environment 113 and the operating system 111. The runtime environment 113 includes a virtual machine 104 that includes various components, such as a memory manager 105, a class file verifier 106, a class loader 107, an interpreter 108, and a just-in-time (JIT) compiler 109. The memory manager 105 may include a garbage collector. The garbage collector may execute garbage collection operations. The class file verifier 106 may check the validity of class files 103. The class loader 107 may locate and build in-memory representations of classes. The interpreter 108 may execute the virtual machine 104 code. The JIT compiler 109 may producing optimized machine-level code.

In an embodiment, the computing architecture 100 includes source code files 101 that contain code that has been written in a particular programming language, such as Java, C, C++, C#, Ruby, Perl, and so forth. Thus, the source code files 101 adhere to a particular set of syntactic and/or semantic rules for the associated language. For example, code written in Java adheres to the Java Language Specification. However, since specifications are updated and revised over time, the source code files 101 may be associated with a version number indicating the revision of the specification. The exact programming language used to write the source code files 101. Various programming languages may be utilized for various different embodiments.

In various embodiments, the compiler 102 may convert the source code, written according to a specification directed to the convenience of the programmer, to either machine or object code that is executable directly by the particular machine environment. Additionally, or alternatively, the compiler 102 may convert the source code to an intermediate representation (“virtual machine code/instructions”) such as bytecode that is executable by a virtual machine 104. The virtual machine 104 may be capable of running on top of a variety of particular machine environments. The virtual machine instructions are executable by the virtual machine 104 in a more direct and efficient manner than the source code. Converting source code to virtual machine instructions includes mapping source code functionality from the language to virtual machine functionality that utilizes underlying resources, such as data structures. Often, functionality that is presented in simple terms via source code by the programmer is converted into more complex steps that map more directly to the instruction set supported by the underlying hardware where the virtual machine 104 resides.

In general, programs are executed either as a compiled or an interpreted program. When a program is compiled, the code is transformed globally from a first language to a second language before execution. Since the work of transforming the code is performed ahead of time; compiled code tends to have excellent run-time performance. In addition, since the transformation occurs globally before execution, the code can be analyzed and optimized using techniques such as constant folding, dead code elimination, inlining, and so forth. However, depending on the program being executed, the startup time can be significant. In addition, inserting new code would require the program to be taken offline, re-compiled, and re-executed. For many dynamic languages (such as Java) that are designed to allow code to be inserted during the program's execution, a purely compiled approach may be inappropriate. When a program is interpreted, the code of the program is read line-by-line and converted to machine-level instructions while the program is executing. As a result, the program has a short startup time (can begin executing almost immediately), but the run-time performance is diminished by performing the transformation on the fly. Furthermore, since each instruction is analyzed individually, many optimizations that rely on a more global analysis of the program cannot be performed.

In some embodiments, the virtual machine 104 includes an interpreter 108 and a JIT compiler 109 (or a component implementing aspects of both), and executes programs using a combination of interpreted and compiled techniques. For example, the virtual machine 104 may initially begin by interpreting the virtual machine instructions representing the program via the interpreter 108 while tracking statistics related to program behavior, such as how often different sections or blocks of code are executed by the virtual machine 104. Once a block of code surpasses a threshold (is “hot”), the virtual machine 104 invokes the JIT compiler 109 to perform an analysis of the block and generate optimized machine-level instructions that replaces the “hot” block of code for future executions. Since programs tend to spend a significant proportion of time executing a small portion of overall code, compiling just the “hot” portions of the program can provide similar performance to fully compiled code, but without the start-up penalty. Furthermore, although the optimization analysis is constrained to the “hot” block being replaced, there still exists far greater optimization potential than converting each instruction individually. There are a number of variations on the above-described example, such as tiered compiling.

To provide clear examples, the source code files 101 have been illustrated as the “top level” representation of the program to be executed by the execution platform 112. Although the computing architecture 100 depicts the source code files 101 as a “top level” program representation, in other embodiments the source code files 101 may be an intermediate representation received via a “higher level” compiler that processed code files in a different language into the language of the source code files 101. Some examples in the following disclosure assume that the source code files 101 adhere to a class-based object-oriented programming language. However, this is not a requirement to utilizing the features described herein.

In an embodiment, compiler 102 receives as input the source code files 101 and converts the source code files 101 into class files 103 that are in a format expected by the virtual machine 104. For example, in the context of the JVM, the Java Virtual Machine Specification defines a particular class file format, and the class files 103 are expected to adhere to the particular class file format. In some embodiments, the class files 103 contain the virtual machine instructions that have been converted from the source code files 101. However, in other embodiments, the class files 103 may contain other structures as well, such as tables identifying constant values and/or metadata related to various structures (classes, fields, methods, and so forth).

The following discussion assumes that each of the class files 103 represents a respective “class” defined in the source code files 101 (or dynamically generated by the compiler 102/virtual machine 104). However, the aforementioned assumption is not a strict requirement and will depend on the implementation of the virtual machine 104. Thus, the techniques described herein may still be performed regardless of the exact format of the class files 103. In some embodiments, the class files 103 are divided into one or more “libraries” or “packages” that respectively include a collection of classes that provide related functionality. For example, a library may contain one or more class files that implement input/output (I/O) operations, mathematics tools, cryptographic techniques, graphics utilities, and so forth. Further, some classes (or fields/methods within those classes) may include access restrictions that limit their use to within a particular class/library/package or to classes with appropriate permissions.

### 3.1 Example Class File Structure

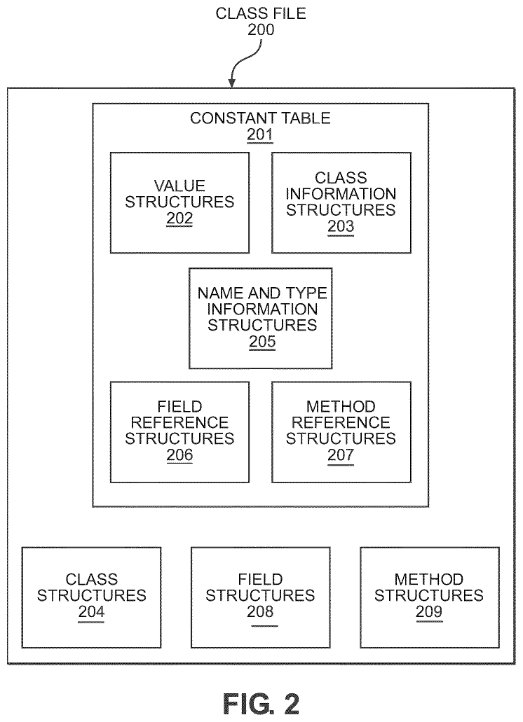

FIG. 2 illustrates an example structure for a class file 200 in block diagram form according to an embodiment. To provide clear examples, the remainder of the disclosure assumes that the class files 103 of the computing architecture 100 adhere to the structure of the example class file 200 described in this section. However, in a practical environment, the structure of the class file 200 will be dependent on the implementation of the virtual machine 104. Further, one or more features discussed herein may modify the structure of the class file 200 to, for example, add additional structure types. Therefore, the exact structure of the class file 200 is not critical to the techniques described herein. For the purposes of Section 2.1, “the class” or “the present class” refers to the class represented by the class file 200.

In FIG. 2, the class file 200 includes a constant table 201, field structures 208, class metadata 207, and method structures 209. In an embodiment, the constant table 201 is a data structure that, among other functions, acts as a symbol table for the class. For example, the constant table 201 may store data related to the various identifiers used in the source code files 101 such as type, scope, contents, and/or location. The constant table 201 has entries for value structures 202 (representing constant values of type int, long, double, float, byte, string, and so forth), class information structures 203, name and type information structures 204, field reference structures 205, and method reference structures 206 derived from the source code files 101 by the compiler 102. In an embodiment, the constant table 201 is implemented as an array that maps an index i to structure j. However, the exact implementation of the constant table 201 is not critical.

In some embodiments, the entries of the constant table 201 include structures that index other constant table 201 entries. For example, an entry for one of the value structures 202 representing a string may hold a tag identifying its “type” as string and an index to one or more other value structures 202 of the constant table 201 storing char, byte or int values representing the ASCII characters of the string.

In an embodiment, field reference structures 205 of the constant table 201 hold an index into the constant table 201 to one of the class information structures 203 representing the class defining the field and an index into the constant table 201 to one of the name and type information structures 204 that provides the name and descriptor of the field. Method reference structures 206 of the constant table 201 hold an index into the constant table 201 to one of the class information structures 203 representing the class defining the method and an index into the constant table 201 to one of the name and type information structures 204 that provides the name and descriptor for the method. The class information structures 203 hold an index into the constant table 201 to one of the value structures 202 holding the name of the associated class.

The name and type information structures 204 hold an index into the constant table 201 to one of the value structures 202 storing the name of the field/method and an index into the constant table 201 to one of the value structures 202 storing the descriptor.

In an embodiment, class metadata 207 includes metadata for the class, such as version number(s), number of entries in the constant pool, number of fields, number of methods, access flags (whether the class is public, private, final, abstract, etc.), an index to one of the class information structures 203 of the constant table 201 that identifies the present class, an index to one of the class information structures 203 of the constant table 201 that identifies the superclass (if any), and so forth.

In an embodiment, the field structures 208 represent a set of structures that identifies the various fields of the class. The field structures 208 store, for each field of the class, accessor flags for the field (whether the field is static, public, private, final, etc.), an index into the constant table 201 to one of the value structures 202 that holds the name of the field, and an index into the constant table 201 to one of the value structures 202 that holds a descriptor of the field.

In an embodiment, the method structures 209 represent a set of structures that identifies the various methods of the class. The method structures 209 store, for each method of the class, accessor flags for the method (e.g. whether the method is static, public, private, synchronized, etc.), an index into the constant table 201 to one of the value structures 202 that holds the name of the method, an index into the constant table 201 to one of the value structures 202 that holds the descriptor of the method, and the virtual machine instructions that correspond to the body of the method as defined in the source code files 101.

In an embodiment, a descriptor represents a type of a field or method. For example, the descriptor may be implemented as a string adhering to a particular syntax. While the exact syntax is not critical, a few examples are described below.

In an example where the descriptor represents a type of the field, the descriptor identifies the type of data held by the field. In an embodiment, a field can hold a basic type, an object, or an array. When a field holds a basic type, the descriptor is a string that identifies the basic type (e.g., “B”=byte, “C”=char, “D”=double, “F”=float, “I”=int, “J”=long int, etc.). When a field holds an object, the descriptor is a string that identifies the class name of the object (e.g., “L ClassName”). “L” in this case indicates a reference, thus “L ClassName” represents a reference to an object of class ClassName. When the field is an array, the descriptor identifies the type held by the array. For example, “[B” indicates an array of bytes, with “[” indicating an array and “B” indicating that the array holds the basic type of byte. However, since arrays can be nested, the descriptor for an array may also indicate the nesting. For example, “[[L ClassName” indicates an array where each index holds an array that holds objects of class ClassName. In some embodiments, the ClassName is fully qualified and includes the simple name of the class, as well as the pathname of the class. For example, the ClassName may indicate where the file is stored in the package, library, or file system hosting the class file 200.

In the case of a method, the descriptor identifies the parameters of the method and the return type of the method. For example, a method descriptor may follow the general form “({ParameterDescriptor}) ReturnDescriptor”, where the {ParameterDescriptor} is a list of field descriptors representing the parameters and the ReturnDescriptor is a field descriptor identifying the return type. For instance, the string “V” may be used to represent the void return type. Thus, a method defined in the source code files 101 as “Object m (int I, double d, Thread t) { . . . }” matches the descriptor “(I D L Thread) L Object”.

In an embodiment, the virtual machine instructions held in the method structures 209 include operations that reference entries of the constant table 201. Using Java as an example, consider the following class:
class A
{
   int add12and13( ){
      return B.addTwo(12, 13);
   }
}

In the above example, the Java method add12and13 is defined in class A, takes no parameters, and returns an integer. The body of method add12 and13 calls static method addTwo of class B. The static method addTwo of class B takes the constant integer values 12 and 13 as parameters, and returns the result. Thus, in the constant table 201, the compiler 102 includes, among other entries, a method reference structure that corresponds to the call to the method B.addTwo. In Java, a call to a method compiles down to an invoke command in the bytecode of the JVM (in this case invokestatic as addTwo is a static method of class B). The invoke command is provided an index into the constant table 201 corresponding to the method reference structure that identifies the class defining addTwo “B”, the name of addTwo “addTwo”, and the descriptor of addTwo “(II)I”. For example, assuming the aforementioned method reference is stored at index 4, the bytecode instruction may appear as “invokestatic #4”.

Since the constant table 201 refers to classes, methods, and fields symbolically with structures carrying identifying information, rather than direct references to a memory location, the entries of the constant table 201 are referred to as “symbolic references”. One reason that symbolic references are utilized for the class files 103 is because, in some embodiments, the compiler 102 is unaware of how and where the classes will be stored once loaded into the runtime environment 113. As will be described in Section 2.3, eventually the run-time representations of the symbolic references are resolved into actual memory addresses by the virtual machine 104 after the referenced classes (and associated structures) have been loaded into the runtime environment and allocated concrete memory locations.

### 3.2 Example Virtual Machine Architecture

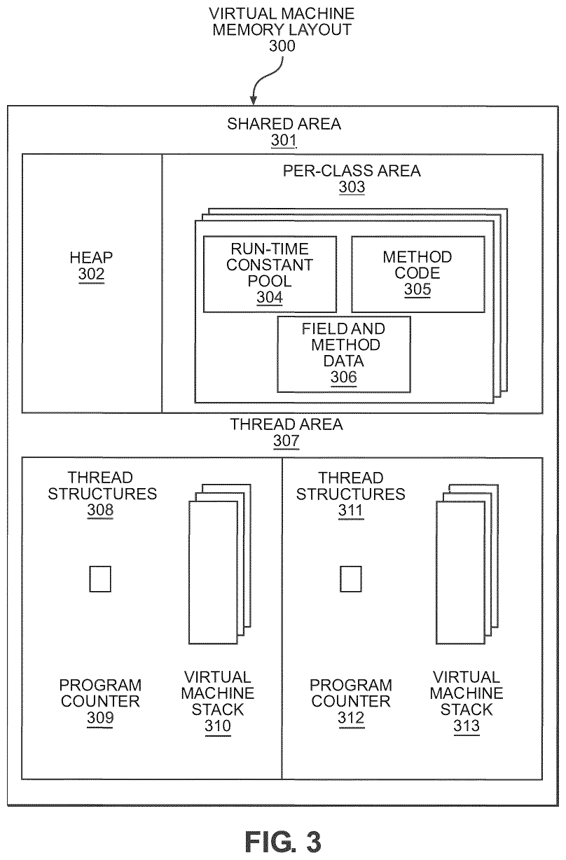

FIG. 3 illustrates an example virtual machine memory layout 300 in block diagram form according to an embodiment. To provide clear examples, the remaining discussion will assume that the virtual machine 104 adheres to the virtual machine memory layout 300 depicted in FIG. 3. In addition, although components of the virtual machine memory layout 300 may be referred to as memory “areas”, there is no requirement that the memory areas be contiguous.

In the example illustrated by FIG. 3, the virtual machine memory layout 300 is divided into a shared area 301 and a thread area 307. The shared area 301 represents an area in memory where structures shared among the various threads executing on the virtual machine 104 are stored. The shared area 301 includes a heap 302 and a per-class area 303. In an embodiment, the heap 302 represents the run-time data area where memory for class instances and arrays is allocated. In an embodiment, the per-class area 303 represents the memory area where the data pertaining to the individual classes are stored. In an embodiment, the per-class area 303 includes, for each loaded class, a run-time constant pool 304 representing data from the constant table 201 of the class, field, and method data 306 (for example, to hold the static fields of the class), and the method code 305 representing the virtual machine instructions for methods of the class.

The thread area 307 represents a memory area where structures specific to individual threads are stored. In FIG. 3, the thread area 307 includes thread structures 308 and thread structures 311, representing the per-thread structures utilized by different threads. To provide clear examples, the thread area 307 depicted in FIG. 3 assumes two threads are executing on the virtual machine 104. However, in a practical environment, the virtual machine 104 may execute any arbitrary number of threads, with the number of thread structures scaled accordingly.

In an embodiment, thread structures 308 includes program counter 309 and virtual machine stack 310. Similarly, thread structures 311 includes program counter 312 and virtual machine stack 313. In an embodiment, program counter 309 and program counter 312 store the current address of the virtual machine instruction being executed by their respective threads.

Thus, as a thread steps through the instructions, the program counters are updated to maintain an index to the current instruction. In an embodiment, virtual machine stack 310 and virtual machine stack 313 each store frames for their respective threads that hold local variables and partial results, and is also used for method invocation and return.

In an embodiment, a frame is a data structure used to store data and partial results, return values for methods, and perform dynamic linking. A new frame is created each time a method is invoked. A frame is destroyed when the method that caused the frame to be generated completes. Thus, when a thread performs a method invocation, the virtual machine 104 generates a new frame and pushes that frame onto the virtual machine stack associated with the thread.

When the method invocation completes, the virtual machine 104 passes back the result of the method invocation to the previous frame and pops the current frame off of the stack. In an embodiment, for a given thread, one frame is active at any point. This active frame is referred to as the current frame, the method that caused generation of the current frame is referred to as the current method, and the class that the current method belongs is referred to as the current class.

Referring further to FIG. 3, in one example, the shared area may include the heap 302 and an off-heap memory 314. One or more memory regions may be located within the heap 302. Each memory region located in the heap 302 may include one or more shared memory segments that are accessible by a set of accessing threads. The off-heap memory 314 may include one or more memory regions located outside the heap 302. Each memory region located in the off-heap memory 314 may include one or more shared memory segments that are accessible by a set of accessing threads. In one example, the off-heap memory 314 and/or a memory region located in the off-heap memory 314 may be managed by an application or by a provisioning thread, for example, instead of the JVM. In one example, the off-heap memory 314 and/or a memory region located in the off-heap memory 314 may be utilized for non-managed data structures, such as large buffers, caches, or custom data models. Additionally, or alternatively, the off-heap memory 314 and/or a memory region located in the off-heap memory 314 may be utilized for data structures that exceed the capacity of the heap 302 and/or that require more efficient memory handling. Additionally, or alternatively, the off-heap memory 314 and/or a memory region located in the off-heap memory 314 may be utilized to provide interaction with native libraries or to provide direct memory access.

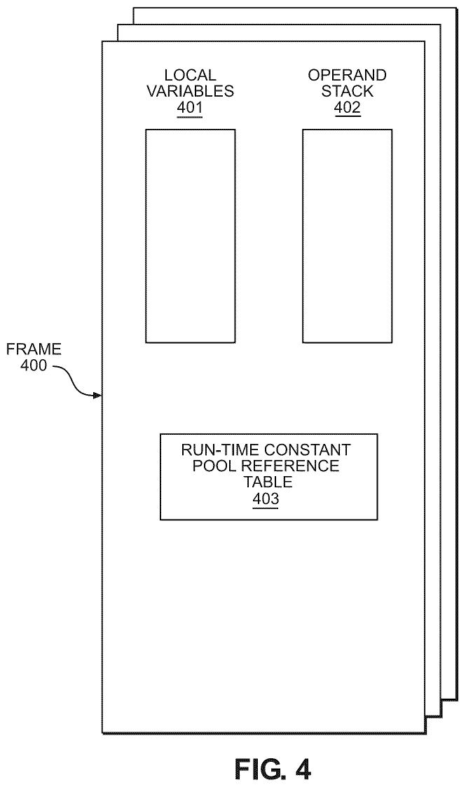

FIG. 4 illustrates an example frame 400 in block diagram form according to an embodiment. To provide clear examples, the remaining discussion will assume that frames of virtual machine stack 310 and virtual machine stack 313 adhere to the structure of frame 400.

In an embodiment, frame 400 includes local variables 401, operand stack 402, and run-time constant pool reference table 403. In an embodiment, the local variables 401 are represented as an array of variables that each hold a value, for example, Boolean, byte, char, short, int, float, or reference. Further, some value types, such as longs or doubles, may be represented by more than one entry in the array. The local variables 401 are used to pass parameters on method invocations and store partial results. For example, when generating the frame 400 in response to invoking a method, the parameters may be stored in predefined positions within the local variables 401, such as indexes 1-N corresponding to the first to Nth parameters in the invocation.

In an embodiment, the operand stack 402 is empty by default when the frame 400 is created by the virtual machine 104. The virtual machine 104 then supplies instructions from the method code 305 of the current method to load constants or values from the local variables 401 onto the operand stack 402. Other instructions take operands from the operand stack 402, operate on them, and push the result back onto the operand stack 402. Furthermore, the operand stack 402 is used to prepare parameters to be passed to methods and to receive method results. For example, the parameters of the method being invoked could be pushed onto the operand stack 402 prior to issuing the invocation to the method. The virtual machine 104 then generates a new frame for the method invocation where the operands on the operand stack 402 of the previous frame are popped and loaded into the local variables 401 of the new frame. When the invoked method terminates, the new frame is popped from the virtual machine stack and the return value is pushed onto the operand stack 402 of the previous frame.

In an embodiment, the run-time constant pool reference table 403 contains a reference to the run-time constant pool 304 of the current class. The run-time constant pool reference table 403 is used to support resolution. Resolution is the process whereby symbolic references in the constant pool 304 are translated into concrete memory addresses, loading classes as necessary to resolve as-yet-undefined symbols and translating variable accesses into appropriate offsets into storage structures associated with the run-time location of these variables.

### 3.3 Loading, Linking, and Initializing

In an embodiment, the virtual machine 104 dynamically loads, links, and initializes classes. Loading is the process of finding a class with a particular name and creating a representation from the associated class file 200 of that class within the memory of the runtime environment 113. For example, creating the run-time constant pool 304, method code 305, and field and method data 306 for the class within the per-class area 303 of the virtual machine memory layout 300. Linking is the process of taking the in-memory representation of the class and combining it with the run-time state of the virtual machine 104 so that the methods of the class can be executed. Initialization is the process of executing the class constructors to set the starting state of the field and method data 306 of the class and/or create class instances on the heap 302 for the initialized class.

The following are examples of loading, linking, and initializing techniques that may be implemented by the virtual machine 104. However, in some embodiments the steps may be interleaved, such that an initial class is loaded, then during linking a second class is loaded to resolve a symbolic reference found in the first class. The loading of the second class, in turn, causes a third class to be loaded, and so forth. Thus, progress through the stages of loading, linking, and initializing can differ from class to class. Further, some embodiments may delay (perform “lazily”) one or more functions of the loading, linking, and initializing process until the class is actually required. For example, resolution of a method reference may be delayed until a virtual machine instruction invoking the method is executed. Thus, the exact timing of when the steps are performed for each class can vary between implementations.

To begin the loading process, the virtual machine 104 starts up by invoking the class loader 107, and the class loader 107 loads an initial class. The technique whereby the initial class is specified will vary from embodiment to embodiment. For example, one technique may have the virtual machine 104 accept a command line argument on startup that specifies the initial class.

To load a class, the class loader 107 parses the class file 200 corresponding to the class and determines whether the class file 200 is well-formed (meets the syntactic expectations of the virtual machine 104). If not, the class loader 107 generates an error. For example, in Java the error might be generated in the form of an exception that is thrown to an exception handler for processing. Otherwise, the class loader 107 generates the in-memory representation of the class by allocating the run-time constant pool 304, method code 305, and field and method data 306 for the class within the per-class area 303.

In some embodiments, when the class loader 107 loads a class, the class loader 107 also recursively loads the super-classes of the loaded class. For example, the virtual machine 104 may ensure that the super-classes of a particular class are loaded, linked, and/or initialized before proceeding with the loading, linking, and initializing process for the particular class.

During linking, the virtual machine 104 verifies the class, prepares the class, and performs resolution of the symbolic references defined in the run-time constant pool 304 of the class.

To verify the class, the virtual machine 104 checks whether the in-memory representation of the class is structurally correct. For example, the virtual machine 104 may check that each class except the generic class Object has a superclass, check that final classes have no sub-classes and final methods are not overridden, check whether constant pool entries are consistent with one another, check whether the current class has correct access permissions for classes/fields/structures referenced in the constant pool 304, check that the virtual machine 104 code of methods will not cause unexpected behavior (e.g. making sure a jump instruction does not send the virtual machine 104 beyond the end of the method), and so forth. The exact checks performed during verification are dependent on the implementation of the virtual machine 104. In some cases, verification may cause additional classes to be loaded, but does not necessarily require those classes to also be linked before proceeding. For example, assume Class A contains a reference to a static field of Class B. During verification, the virtual machine 104 may check Class B to ensure that the referenced static field actually exists, and this might cause loading of Class B, but not necessarily the linking or initializing of Class B. However, in some embodiments, certain verification checks can be delayed until a later phase, such as being checked during resolution of the symbolic references. For example, some embodiments may delay checking the access permissions for symbolic references until those references are being resolved.

To prepare a class, the virtual machine 104 initializes static fields located within the field and method data 306 for the class to default values. In some cases, setting the static fields to default values may not be the same as running a constructor for the class. For example, the verification process may zero out or set the static fields to values that the constructor would expect those fields to have during initialization.

During resolution, the virtual machine 104 dynamically determines concrete memory address from the symbolic references included in the run-time constant pool 304 of the class. To resolve the symbolic references, the virtual machine 104 utilizes the class loader 107 to load the class identified in the symbolic reference (if not already loaded). Once loaded, the virtual machine 104 has knowledge of the memory location within the per-class area 303 of the referenced class and its fields/methods. The virtual machine 104 then replaces the symbolic references with a reference to the concrete memory location of the referenced class, field, or method. In an embodiment, the virtual machine 104 caches resolutions to be reused in case the same class/name/descriptor is encountered when the virtual machine 104 processes another class. For example, in some cases, class A and class B may invoke the same method of class C. Thus, when resolution is performed for class A, that result can be cached and reused during resolution of the same symbolic reference in class B to reduce overhead.

In some embodiments, the step of resolving the symbolic references during linking is optional. For example, an embodiment may perform the symbolic resolution in a “lazy” fashion, delaying the step of resolution until a virtual machine instruction that requires the referenced class/method/field is executed.

During initialization, the virtual machine 104 executes the constructor of the class to set the starting state of that class. For example, initialization may initialize the field and method data 306 for the class and generate/initialize any class instances on the heap 302 created by the constructor. For example, the class file 200 for a class may specify that a particular method is a constructor that is used for setting up the starting state. Thus, during initialization, the virtual machine 104 executes the instructions of that constructor.

In some embodiments, the virtual machine 104 performs resolution on field and method references by initially checking whether the field/method is defined in the referenced class. Otherwise, the virtual machine 104 recursively searches through the super-classes of the referenced class for the referenced field/method until the field/method is located or until the top-level superclass is reached. If the top-level super class is reached, an error may be generated.

### 4. Example Memory Allocation Constraints Determined from Calling Relationships in a Call Stack

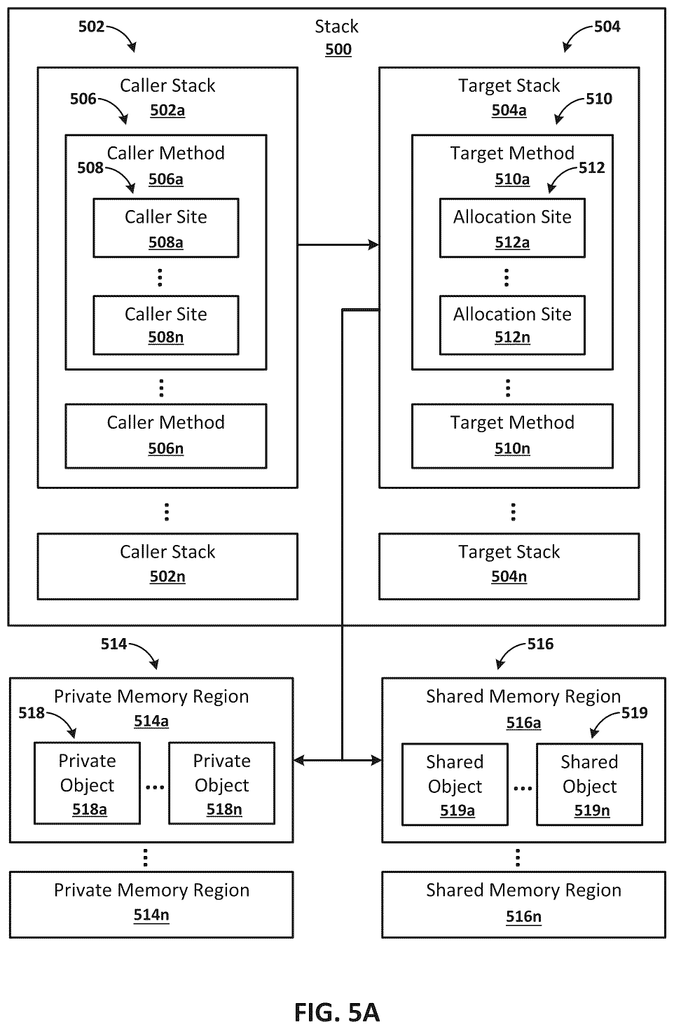

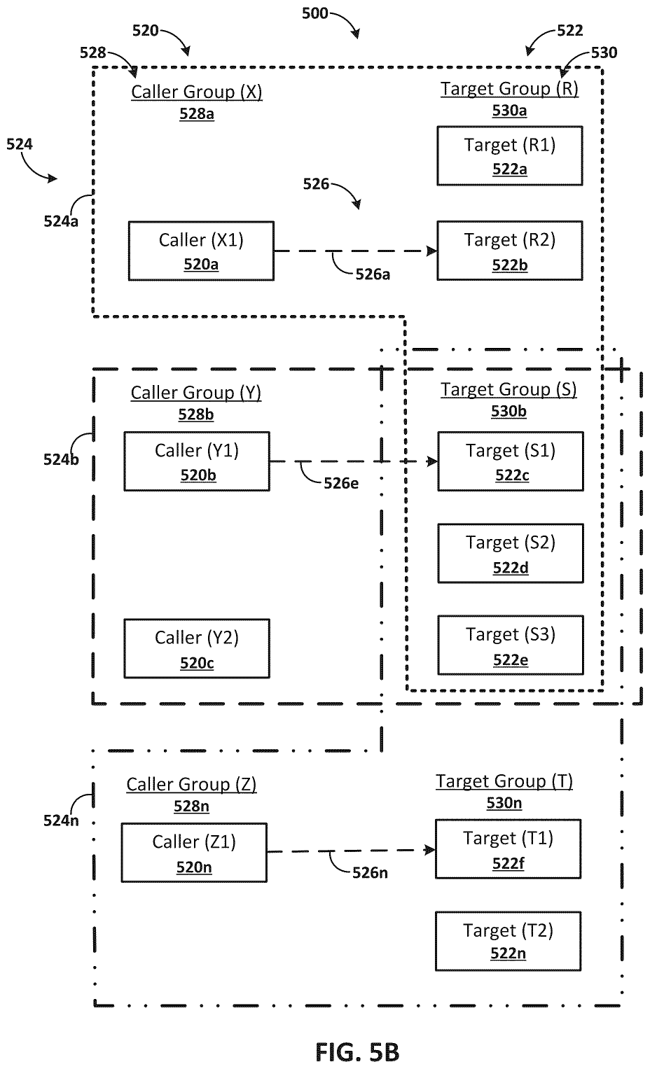

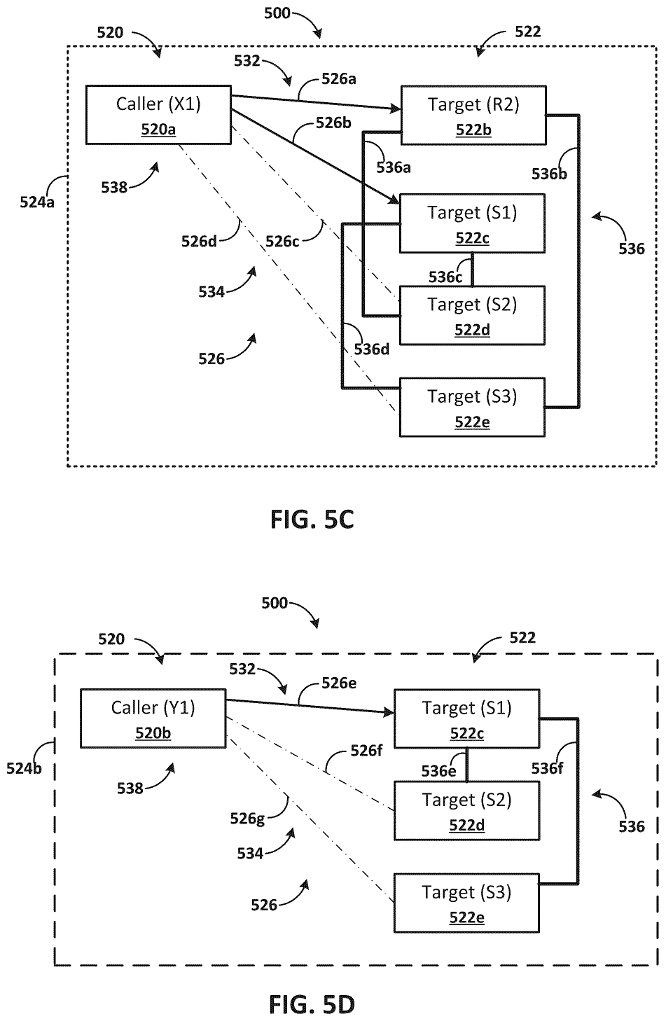

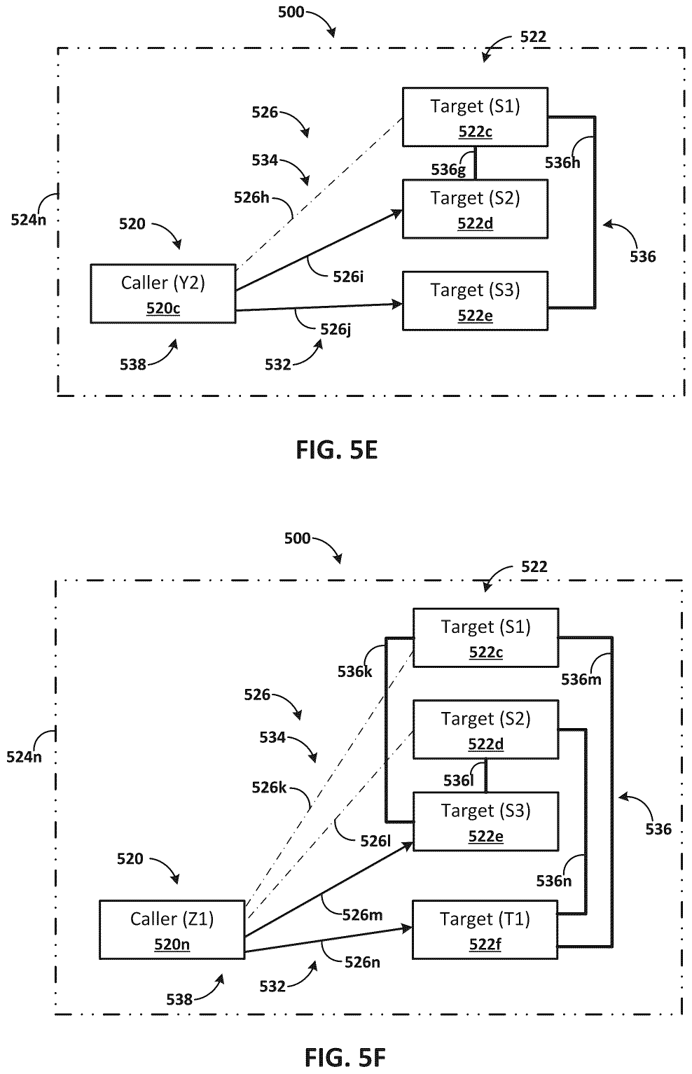

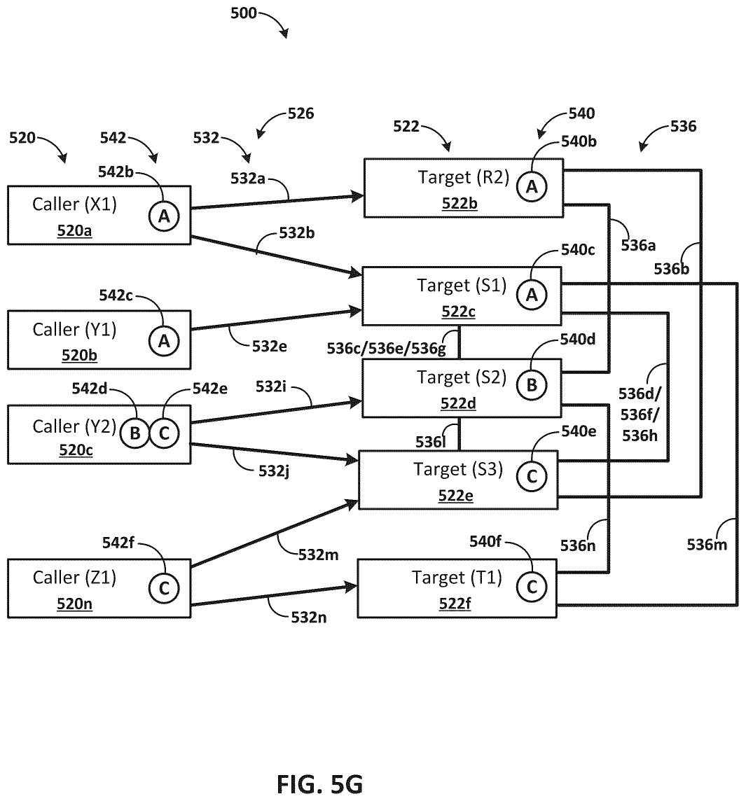

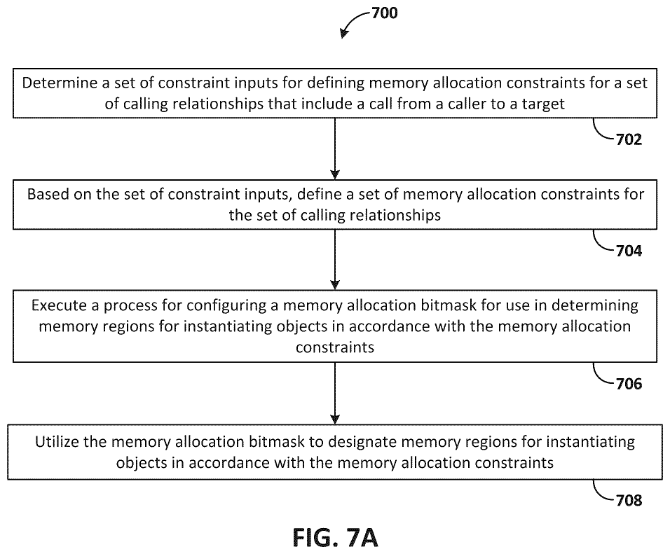

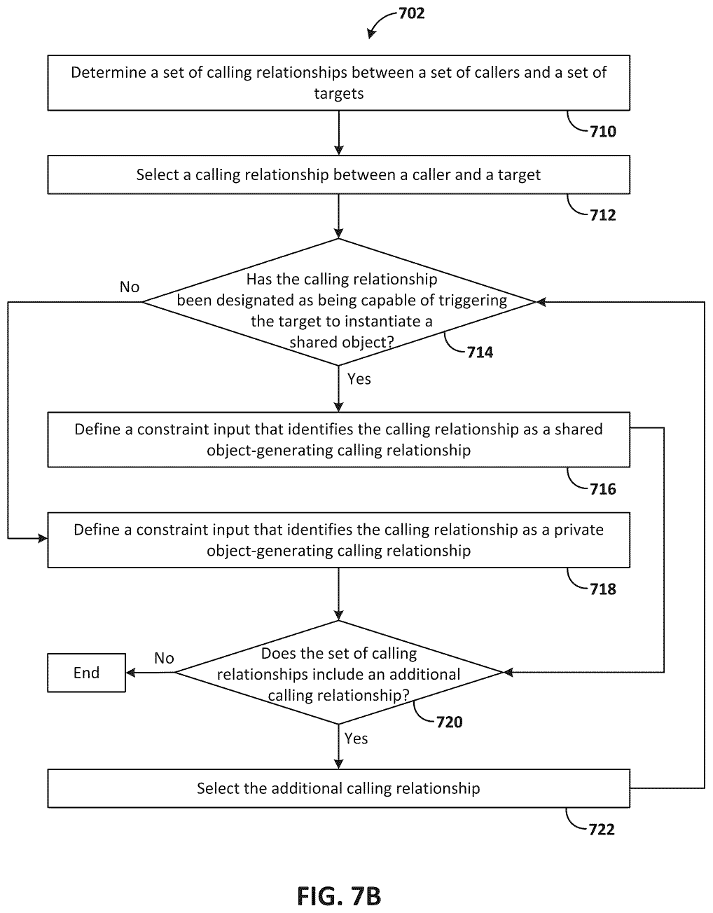

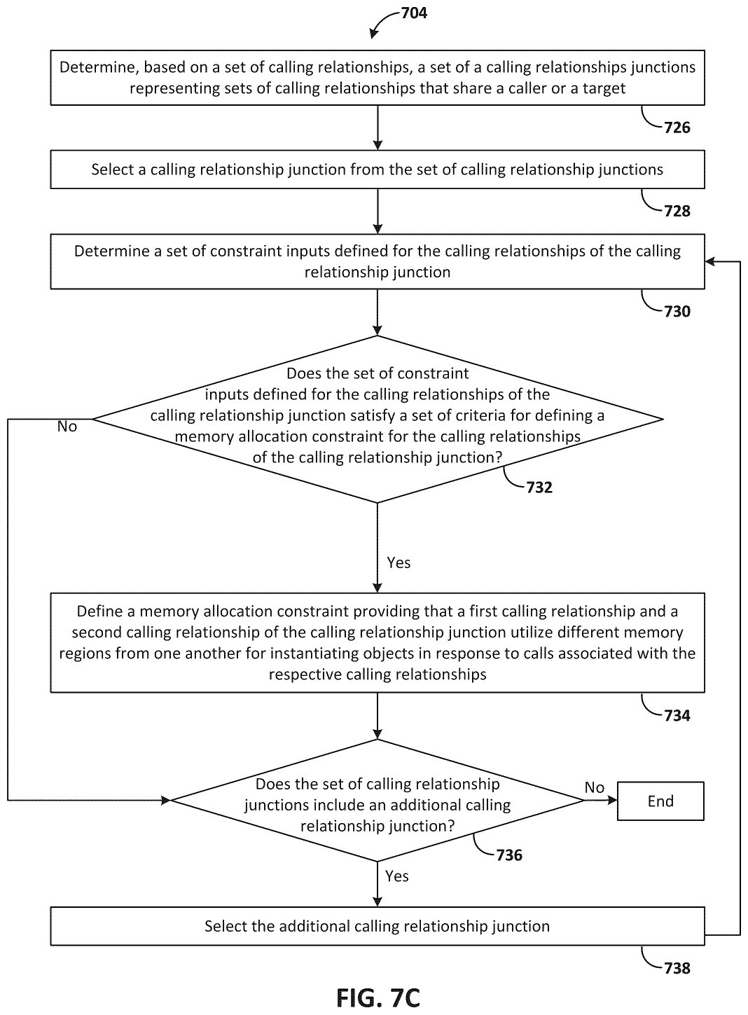

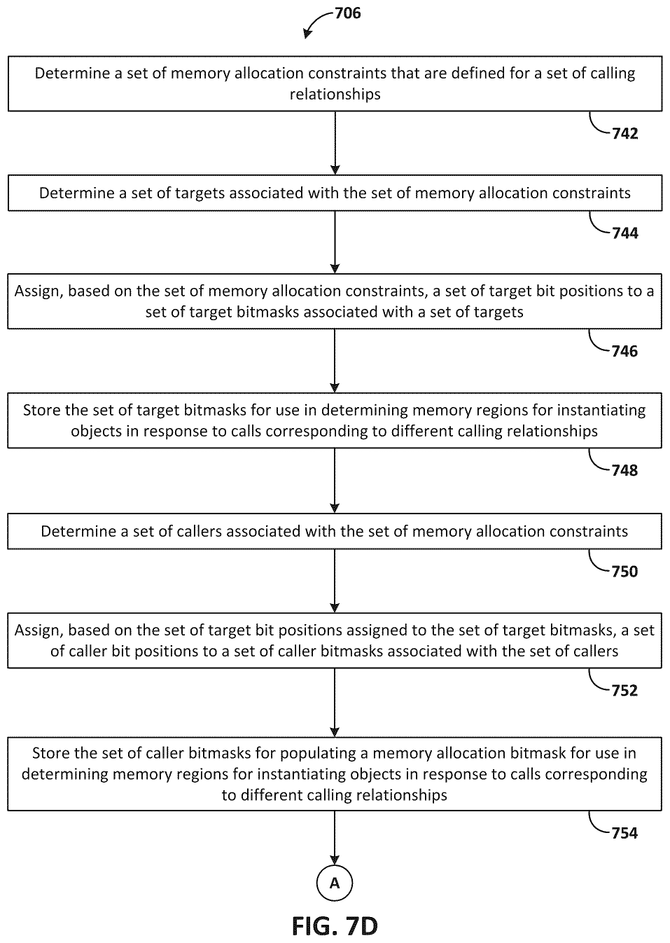

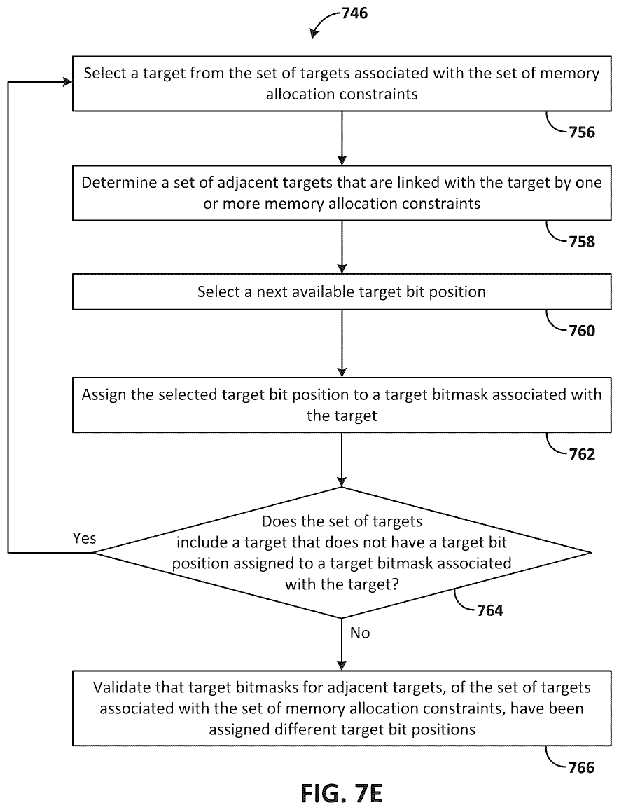

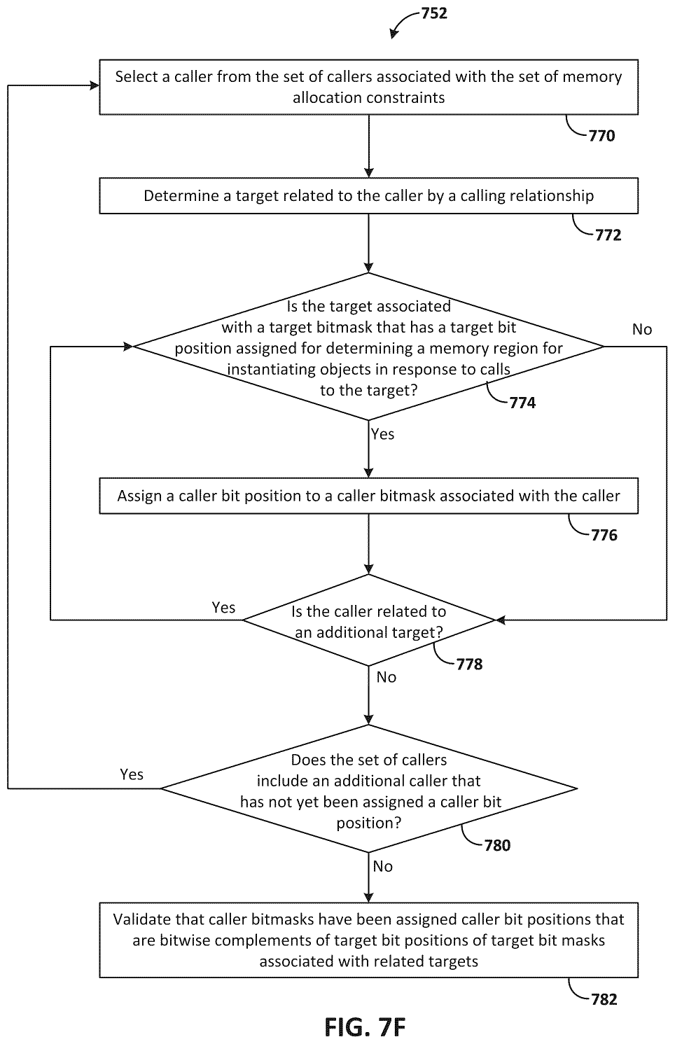

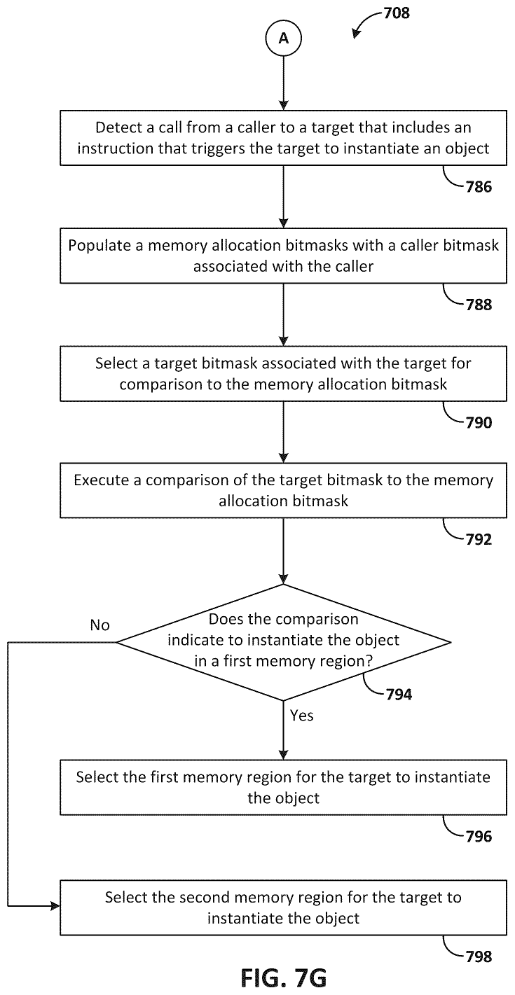

Referring now to FIGS. 5A-5G, example memory allocation constraints that are determined from calling relationships in a call stack are further described. One or more features described with reference to FIGS. 5A-5G may be combined, modified, or omitted. In one example, the features described with reference to FIGS. 5A-5G may be implemented and/or utilized by one or more features of the system described with reference to FIGS. 1-4. Additionally, or alternatively, the features described with reference to FIGS. 5A-5G may be generated and/or utilized in one or more of the operations described with reference to FIGS. 7A-7G.

### 4.1 Example Call Stacks

As shown in FIG. 5A, a system includes one or more stacks 500. A stack 500 includes one or more caller stacks 502 and one or more target stacks 504. For example, the stack 500 may include caller stack 502a and caller stack 502n. Additionally, or alternatively, the stack 500 may include target stack 504a and target stack 504n. As shown with reference to call stack 502a, a call stack 502 includes one or more caller methods 506, such as caller method 506a and caller method 506n. As shown with reference to caller method 506a, a caller method 506 may include one or more call sites 508, such as caller site 508a and caller site 508n. As shown with reference to target stack 504a, a target stack 504 includes one or more target methods 510, such as target method 510a and target method 510n. As shown with reference to target method 510a, a target method 510 may include one or more allocation sites 512, such as allocation site 512a and allocation site 512n.

The caller methods 506 may represent discrete methods and/or inlined caller methods. The inlined caller methods include code that represents one or more target methods 510 that have been added to a caller method 506 in lieu of having the caller method 506 make calls to the one or more target methods 510. A caller stack 502 may include caller methods 506 that have multiple levels of inlining. The target methods 510 in a target stack 504 may represent target methods that exceed an inlining threshold and thus are not included in an inlined caller method of the caller stack 502.

A caller methods 506 may call one or more target methods 510. For example, caller method 506a may call target method 510a. A call from a caller method to a target method 510 may trigger the target method to instantiate one or more objects. The call may include an instruction to instantiate an object. Additionally, or alternatively, the call may trigger the target method to execute one or more operations that includes an instruction to instantiate an object. A call from a caller method 506 to a target method 510 can be initiated from one or more caller sites 508 of the caller method 506. For example, caller site 508a and/or caller site 508n may call target method 510a. A call to a target method 510 may trigger the target method 510 to execute one or more allocation sites to instantiate an object. For example, a call to target method 510a may trigger target method 510a to execute allocation site 512a and/or 512n. The allocation site 512 of a target method 510 that is executed may depend on one or more instructions in the call and/or on one or more operations that are executed by the target method in response to the call. The objects that are instantiated in response to a call may be shared objects or private objects. Whether the object is a shared object or a private object may depend on one or more instructions in the call and/or on the one or more operations executed by the target method in response to the call.

The system includes one or more private memory regions 514, such as private memory region 514a and private memory region 514n. Additionally, the system includes one or more shared memory regions 516, such as shared memory region 516a and shared memory region 516n. One or more target methods 510 may instantiate one or more private objects 518 in a private memory region 514 in response to a call from a caller method 506. For example, as shown in FIG. 5A, one or more target methods 510 have instantiated private object 518a and private object 518n in private memory region 514a. Additionally, or alternatively, one or more target methods 510 may instantiate one or more shared objects 519 in a shared memory region 516 in response to a call from a caller method 506. For example, as shown in FIG. 5A, one or more target methods 510 have instantiated shared object 519a and shared object 519n in shared memory region 516a.

### 4.2 Example Calling Relationships

Referring to FIG. 5B, example calling relationships are further described. As shown in FIG. 5B, the stack 500 includes a set of callers 520 and a set of targets 522. The callers 520 may include caller methods 506 (FIG. 5A) and/or caller sites 508 (FIG. 5A). The targets 522 may include target methods 510 (FIG. 5A) and/or allocation sites 512 (FIG. 5A). In one example, the callers 520 are grouped by caller method 506 (FIG. 5A). In one example, the targets 522 are grouped by target method 510 (FIG. 5A). A caller 520 may be capable of calling one or more targets 522. The stack 500 include one or more calling families 524, such as calling family 524a, calling family 524b, and calling family 524n. A calling family 524 includes at least one calling relationship 526 between a caller 520 and a target 522, such as calling relationship 526a, calling relationship 526b, and calling relationship 526n. Additionally, a calling family 524 includes one or more caller groups 528 and one or more target groups 530. The one or more caller groups 528 include one or more callers 520 and one or more targets 522. The callers 520 in the one or more caller groups 528 of a calling family 524 have a calling relationship 526 with the targets 522 in the one or more target groups 530 of the calling family.

As shown in FIG. 5B, calling family 524a includes caller group (X) 528a. Caller group (X) includes caller (X1) 520a. In one example, caller (X1) 520a is a caller method 506 (FIG. 5A). In one example, caller (X1) 520a is a call site 508 of a caller method 506 (FIG. 5A). Additionally, calling family 524a includes target group (R) 530a and target group (S) 530b. Target group (R) includes target (R1) 522a and target (R2) 522b. Target group(S) includes target (S1) 522c, target (S2) 522d, and target (S3) 522e. In one example, target (R1) 522a and target (R2) 522b are target methods 510 (FIG. 5A). In one example, target (R1) 522a and target (R2) 522b are allocation sites 512 of a target method 510 (FIG. 5A). Calling family 524a includes calling relationship 526a between caller (X1) 520a and target (R2) 522b. Additionally, calling family 524a includes calling relationships 526 between caller (X1) 520a and the following targets 522: target (R1) 522a, target (R2) 522b, target (S1) 522c, target (S2) 522d, and target (S3) 522e.

Calling family 524b includes caller group (Y) 528b. Caller group (Y) 528b includes caller (Y1) 520b and caller (Y2) 520c. In one example, caller (Y1) 520b and caller (Y2) 520c are caller methods 506 (FIG. 5A). In one example, caller (Y1) 520b and caller (Y2) 520c are call sites 508 of a caller method 506 (FIG. 5A). Additionally, calling family 524a includes target group(S) 530b, including target (S1) 522c, target (S2) 522d, and target (S3) 522e. In one example, target (S1) 522c, target (S2) 522d, and target (S3) 522e are target methods 510 (FIG. 5A). In one example, target (S1) 522c, target (S2) 522d, and target (S3) 522e are allocation sites 512 of a target method 510 (FIG. 5A). Calling family 524b includes calling relationship 526e between caller (Y1) 520b and target (S1) 522c. Additionally, calling family 524b includes calling relationships 526 between caller (Y1) 520b and the following targets 522: target (S2) 522d and target (S3) 522e. Additionally, calling family 524b includes calling relationships 526 between caller (Y2) 520c and the following targets 522: target (S1) 522c, target (S2) 522d, and target (S3) 522e.

Calling family 524n includes caller group (Z) 528n. Caller group (Z) 528n includes caller (Z1) 520n. In one example, caller (Z1) 520n is a caller method 506 (FIG. 5A). In one example, caller (Z1) 520n is a call site 508 of a caller method 506 (FIG. 5A). Additionally, calling family 524n includes target group(S) 530b (including target (S1) 522c, target (S2) 522d, and target (S3) 522e) and target group (T). Target group (T) includes target (T1) 522f and target (T2) 522n. In one example, target (T1) 522f and target (T2) 522n are target methods 510 (FIG. 5A). In one example, target (T1) 522f and target (T2) 522n are allocation sites 512 of a target method 510 (FIG. 5A). Calling family 524n includes calling relationship 526n between caller (Z1) 520n and target (T1) 522f. Additionally, calling family 524b includes calling relationships 526 between caller (Z1) 520n and the following targets 522: target (S1) 522c, target (S2) 522d, target (S3) 522e, and target (T2) 522n.

Referring to FIGS. 5C-5F, example calling relationships 526 are further described. For or more of the calling relationships 526, a call from the caller 520 to the target 522 may be capable of triggering the target 522 to instantiate a shared object. In one example, one or more calling relationships 526 are a shared object-generating relationship 532. Additionally, or alternatively, one or more calling relationships 526 are a private object-generating relationship 534. Shared object-generating relationships 532 are depicted in FIGS. 5C-5F as a solid bold line between a caller 520 and a target 522. Private object-generating relationships 534 are depicted in FIGS. 5C-5F as a dashed lightweight line between a caller 520 and a target 522.

In one example, a calling relationships 526 is a shared object-generating relationship 532 when a call from the caller 520 to the target 522 of the calling relationship 526 is capable of triggering the target 522 to instantiate a shared object. A shared object-generating relationship 532 may be determined based on one or more occurrence of a call from the caller 520 to the target 522 triggering the target 522 to instantiate a shared object. The one or more occurrences of a call triggering a target 522 to instantiate a shared object may be determined based on a static analysis that is performed without executing code and/or based on a dynamic analysis that is performed while executing code. The dynamic analysis may be performed in a production environment and/or in a testing environment. In one example, a calling relationship 526 is a considered a shared object-generating relationship 532 when at least one call from the caller 520 to the target 522 of the calling relationship 526 has triggered the target 522 to instantiate a shared object. Some calls from the caller 520 to the target 522 of a shared object-generating relationship 532 may trigger the target 522 to generate private objects. In one example, a calling relationship 526 is considered a shared object-generating relationship 532 when a proportion of calls from the caller 520 to the target 522 of the calling relationship 526 that trigger the target 522 to instantiate a shared object meets a threshold.

In one example, a calling relationship 526 is a private object-generating relationship 534 when calls from the caller 520 to the target 522 of the calling relationship 526 are deemed not to trigger the target 522 to instantiate a shared object. Calls from the caller 520 to the target 522 of the calling relationship 526 may be deemed not to trigger the target 522 to instantiate a shared object when the calls have yet to trigger the target 522 to instantiate a shared object. In one example, calling relationships 526 are presumed to be private object-generating relationships 534 when the calls from the caller 520 to the target 522 of the calling relationship 526 have yet to trigger the target 522 to instantiate a shared object. Additionally, or alternatively, a calling relationships 526 may be presumed to be private object-generating relationships 534 unless and/or until one or more occurrences are observed where a call from the caller 520 to the target 522 of the calling relationship 526 triggers the target 522 to instantiate a shared object. In one example, a calling relationships 526 is considered a private object-generating relationships 534 provided that no occurrences are observed where a call from the caller 520 to the target 522 of the calling relationship 526 triggers the target 522 to instantiate a shared object. In one example, a calling relationships 526 is considered a private object-generating relationships 534 provided that a proportion of calls from the caller 520 to the target 522 of the calling relationship 526 that trigger the target 522 to instantiate a shared object remains below a threshold.

In one example, upon one or more occurrences of a call from a caller 520 to a target 522 of a calling relationship 526 that is considered a private object-generating relationship 534 triggering the target 522 to instantiate one or more shared objects, the calling relationship 526 may cease being considered a private object-generating relationship 534. Additionally, or alternatively, upon one or more occurrences of a call from a caller 520 to a target 522 of a calling relationship 526 that is considered a private object-generating relationship 534 triggering the target 522 to instantiate one or more shared objects, the calling relationship 526 may begin being considered a shared object-generating relationship 532.

As shown in FIG. 5C, calling family 524a includes the following calling relationships 526: calling relationship 526a between caller (X1) 520a and target (R2) 522b; calling relationship 526b between caller (X1) 520a and target (S1) 522c; calling relationship 526c between caller (X1) 520a and target (S2) 522d; and calling relationship 526d between caller (X1) 520a and target (S3) 522e. Calling relationship 526a and calling relationship 526b are shared object-generating relationships 532. Caller (X1) 520a is capable of directing a call to target (R2) 522b that triggers target (R2) 522b to instantiate a shared object. Additionally, caller (X1) 520a is capable of directing a call to target (S1) 522c that triggers target (S1) 522c to instantiate a shared object. Calling relationship 526c and calling relationship 526d are private object-generating relationships 534. Caller (X1) 520a has yet to direct a call to target (S2) 522d that triggers target (S2) 522d to instantiate a shared object. Additionally, caller (X1) 520a has yet to direct a call to target (S3) 522e that triggers target (S3) 522e to instantiate a shared object.

As shown in FIG. 5D, calling family 524b includes the following calling relationships 526: calling relationship 526e between caller (Y1) 520b and target (S1) 522c; calling relationship 526f between caller (Y1) 520b and target (S2) 522d; and calling relationship 526g between caller (Y1) 520b and target (S3) 522e. Calling relationship 526e is a shared object-generating relationship 532. Caller (Y1) 520b is capable of directing a call to target (S1) 522c that triggers target (S1) 522c to instantiate a shared object. Calling relationship 526f and calling relationship 526g are private object-generating relationships 534. Caller (Y1) 520b has yet to direct a call to target (S2) 522d that triggers target (S2) 522d to instantiate a shared object. Additionally, caller (Y1) 520b has yet to direct a call to target (S3) 522e that triggers target (S3) 522e to instantiate a shared object.

As shown in FIG. 5E, calling family 524n includes the following calling relationships 526: calling relationship 526h between caller (Y2) 520c and target (S1) 522c; calling relationship 526i between caller (Y2) 520c and target (S2) 522d; and calling relationship 526j between caller (Y2) 520c and target (S3) 522e. Calling relationship 526h is a private object-generating relationship 534. Caller (Y2) 520c has yet to direct a call to target (S1) 522c that triggers target (S1) 522c to instantiate a shared object. Calling relationship 526i and calling relationship 526j are shared object-generating relationships 532. Caller (Y2) 520c is capable of directing a call to target (S2) 522d that triggers target (S2) 522d to instantiate a shared object. Additionally, caller (Y2) 520c is capable of directing a call to target (S3) 522e that triggers target (S3) 522e to instantiate a shared object.

As shown in FIG. 5F, calling family 524n further includes the following calling relationships 526: calling relationship 526k between caller (Z1) 520n and target (S1) 522c; calling relationship 526l between caller (Z1) 520n and target (S2) 522d; calling relationship 526m between caller (Z1) 520n and target (S3) 522e; and calling relationship 526n between caller (Z1) 520n and target (T1) 522f. Calling relationship 526k and calling relationship 526l are private object-generating relationships 534. Caller (Z1) 520n has yet to direct a call to target (S1) 522c that triggers target (S1) 522c to instantiate a shared object. Additionally, caller (Z1) 520n has yet to direct a call to target (S2) 522d that triggers target (S2) 522d to instantiate a shared object. Calling relationship 526m and calling relationship 526n are shared object-generating relationships 532. Caller (Z1) 520n is capable of directing a call to target (S3) 522e that triggers target (S3) 522e to instantiate a shared object. Additionally, caller (Z1) 520n is capable of directing a call to target (T1) 522f that triggers target (T1) 522f to instantiate a shared object.

### 4.3 Example Memory Allocation Constraints

Referring further to FIGS. 5C-5F, in one example, one or more calling relationships 526 are utilized as constraint inputs for determining memory allocation constraints 536. The memory allocation constraints may include constraints that objects instantiated based on shared object-generating relationships 532 and objects instantiated based on private object-generating relationships 534 be instantiated in different memory regions from one another. Objects instantiated based on shared object-generating relationships 532 may be instantiated in a first memory region, and objects instantiated based on private object-generating relationships 534 may be instantiated in a second memory region.

As shown in FIGS. 5C-5F, the calling relationships 526 include calling relationship junctions 538, where a set of calling relationships 526, such as a first calling relationship 526 and a second calling relationship 526, share a caller 520 or a target 522. In one example, memory allocation constraints 536 are defined for calling relationship junctions 538 between a shared object-generating relationship 532 and a private object-generating relationship 534. Additionally, or alternatively, memory allocation constraints 536 are defined when one calling relationship 526 of the calling relationship junction 538 is a shared object-generating relationship 532, and another calling relationship 526 of the calling relationship junction 538 is a private object-generating relationship 534. A memory allocation constraint 536 may provide that objects instantiated based on the shared object-generating relationship 532 of a calling relationship junction 538 and objects instantiated based on the private object-generating relationships 534 of the calling relationship junction 538 be instantiated in different memory regions from one another.

In accordance with the memory allocation constraints 536, when a call from a caller 520 to a target 522 of a shared object-generating relationship 532 triggers the target 522 to instantiate an object, the target 522 instantiates the object in the first memory region. The first memory region may be allocated for instantiating shared objects. Additionally, or alternatively, the first memory region may be allocated for instantiating objects that have a potential of being shared objects. Additionally, in accordance with the memory allocation constraints 536, when a call from a caller 520 to a target 522 of a private object-generating relationship 534 triggers the target 522 to instantiate an object, the target 522 instantiates the object in the second memory region. The second memory region may be allocated for instantiating private objects.

As shown in FIG. 5C, the following memory allocation constraints 536 are associated with calling relationship junctions 538 between calling relationships 526 of calling family 524a: memory allocation constraint 536a, memory allocation constraint 536b, memory allocation constraint 536c, and memory allocation constraint 536d.

Memory allocation constraint 536a is based on a calling relationship junction 538 at caller (X1) 520a between calling relationship 526a and calling relationship 526c. Because calling relationship 526a is a shared object-generating relationship 532 and calling relationship 526c is a private object-generating relationship 534, memory allocation constraint 536a provides that objects instantiated based on calling relationship 526a and objects instantiated based on calling relationship 526c be instantiated in different memory regions from one another. Objects instantiated based on calling relationship 526a may be instantiated to a first memory region such as a memory region allocated for instantiating shared objects and/or objects that have a potential of being shared objects. Objects instantiated based on calling relationship 526c may be instantiated to a second memory region such as a memory region allocated for instantiating private objects.

Memory allocation constraint 536b is based on a calling relationship junction 538 at caller (X1) 520a between calling relationship 526a and calling relationship 526d. Because calling relationship 526a is a shared object-generating relationship 532 and calling relationship 526d is a private object-generating relationship 534, memory allocation constraint 536b provides that objects instantiated based on calling relationship 526a and objects instantiated based on calling relationship 526d be instantiated in different memory regions from one another. Objects instantiated based on calling relationship 526d may be instantiated to the second memory region such as the memory region allocated for instantiating private objects.

Memory allocation constraint 536c is based on a calling relationship junction 538 at caller (X1) 520a between calling relationship 526b and calling relationship 526c. Because calling relationship 526b is a shared object-generating relationship 532 and calling relationship 526c is a private object-generating relationship 534, memory allocation constraint 536c provides that objects instantiated based on calling relationship 526b and objects instantiated based on calling relationship 526c be instantiated in different memory regions from one another. Objects instantiated based on calling relationship 526b may be instantiated to the first memory region, such as the memory region allocated for instantiating shared objects and/or objects that have a potential of being shared objects.

Memory allocation constraint 536d is based on a calling relationship junction 538 at caller (X1) 520a between calling relationship 526b and calling relationship 526d. Because calling relationship 526b is a shared object-generating relationship 532 and calling relationship 526d is a private object-generating relationship 534, memory allocation constraint 536d provides that objects instantiated based on calling relationship 526b and objects instantiated based on calling relationship 526d be instantiated in different memory regions from one another.

As shown in FIG. 5D, the following memory allocation constraints 536 are associated with calling relationship junctions 538 between calling relationships 526 of calling family 524b: memory allocation constraint 536e and memory allocation constraint 536f. Memory allocation constraint 536e is based on a calling relationship junction 538 at caller (Y1) 520b between calling relationship 526e and calling relationship 526f. Because calling relationship 526e is a shared object-generating relationship 532 and calling relationship 526f is a private object-generating relationship 534, memory allocation constraint 536e provides that objects instantiated based on calling relationship 526e and objects instantiated based on calling relationship 526f be instantiated in different memory regions from one another. Objects instantiated based on calling relationship 526e may be instantiated to a first memory region, such as a memory region allocated for instantiating shared objects and/or objects that have a potential of being shared objects. Objects instantiated based on calling relationship 526f may be instantiated to a second memory region such as a memory region allocated for instantiating private objects.

Memory allocation constraint 536f is based on a calling relationship junction 538 at caller (Y1) 520b between calling relationship 526e and calling relationship 526g. Because calling relationship 526e is a shared object-generating relationship 532 and calling relationship 526g is a private object-generating relationship 534, memory allocation constraint 536f provides that objects instantiated based on calling relationship 526e and objects instantiated based on calling relationship 526g be instantiated in different memory regions from one another. Objects instantiated based on calling relationship 526g may be instantiated to the second memory region such as the memory region allocated for instantiating private objects.

As shown in FIG. 5E, the following memory allocation constraints 536 are associated with calling relationship junctions 538 between calling relationships 526 of calling family 524n: memory allocation constraint 536g and memory allocation constraint 536h. Memory allocation constraint 536g is based on a calling relationship junction 538 at caller (Y2) 520c between calling relationship 526i and calling relationship 526h. Because calling relationship 526i is a shared object-generating relationship 532 and calling relationship 526h is a private object-generating relationship 534, memory allocation constraint 536g provides that objects instantiated based on calling relationship 526i and objects instantiated based on calling relationship 526h be instantiated in different memory regions from one another. Objects instantiated based on calling relationship 526i may be instantiated to a first memory region, such as a memory region allocated for instantiating shared objects and/or objects that have a potential of being shared objects. Objects instantiated based on calling relationship 526h may be instantiated to a second memory region such as a memory region allocated for instantiating private objects.

Memory allocation constraint 536h is based on a calling relationship junction 538 at caller (Y2) 520c between calling relationship 526j and calling relationship 526h. Because calling relationship 526j is a shared object-generating relationship 532 and calling relationship 526h is a private object-generating relationship 534, memory allocation constraint 536h provides that objects instantiated based on calling relationship 526j and objects instantiated based on calling relationship 526h be instantiated in different memory regions from one another. Objects instantiated based on calling relationship 526j may be instantiated to the first memory region, such as the memory region allocated for instantiating shared objects and/or objects that have a potential of being shared objects.

As shown in FIG. 5F, the following additional memory allocation constraints 536 are associated with calling relationship junctions 538 between calling relationships 526 of calling family 524n: memory allocation constraint 536k, memory allocation constraint 536l, memory allocation constraint 536m, and memory allocation constraint 536n.

Memory allocation constraint 536k is based on a calling relationship junction 538 at caller (Z1) 520n between calling relationship 526m and calling relationship 526k. Because calling relationship 526m is a shared object-generating relationship 532 and calling relationship 526k is a private object-generating relationship 534, memory allocation constraint 536k provides that objects instantiated based on calling relationship 526m and objects instantiated based on calling relationship 526k be instantiated in different memory regions from one another. Objects instantiated based on calling relationship 526m may be instantiated to a first memory region, such as a memory region allocated for instantiating shared objects and/or objects that have a potential of being shared objects. Objects instantiated based on calling relationship 526k may be instantiated to a second memory region such as a memory region allocated for instantiating private objects.

Memory allocation constraint 536l is based on a calling relationship junction 538 at caller (Z1) 520n between calling relationship 526m and calling relationship 526l. Because calling relationship 526m is a shared object-generating relationship 532 and calling relationship 526l is a private object-generating relationship 534, memory allocation constraint 536k provides that objects instantiated based on calling relationship 526m and objects instantiated based on calling relationship 526l be instantiated in different memory regions from one another. Objects instantiated based on calling relationship 526l may be instantiated to the second memory region such as the memory region allocated for instantiating private objects.

Memory allocation constraint 536m is based on a calling relationship junction 538 at caller (Z1) 520n between calling relationship 526n and calling relationship 526k. Because calling relationship 526n is a shared object-generating relationship 532 and calling relationship 526k is a private object-generating relationship 534, memory allocation constraint 536k provides that objects instantiated based on calling relationship 526n and objects instantiated based on calling relationship 526k be instantiated in different memory regions from one another. Objects instantiated based on calling relationship 526n may be instantiated to the first memory region, such as the memory region allocated for instantiating shared objects and/or objects that have a potential of being shared objects.

Memory allocation constraint 536n is based on a calling relationship junction 538 at caller (Z1) 520n between calling relationship 526n and calling relationship 526l. Because calling relationship 526n is a shared object-generating relationship 532 and calling relationship 526l is a private object-generating relationship 534, memory allocation constraint 536k provides that objects instantiated based on calling relationship 526n and objects instantiated based on calling relationship 526l be instantiated in different memory regions from one another.

Referring further to FIGS. 5C-5F, in addition to the memory allocation constraints 536 described above, memory allocation constraints 536 may additionally, or alternatively, be based on one or more calling relationship junctions 538, where target 522 is shared between a shared object-generating relationship 532 and a private object-generating relationship 534. In one example, with reference to FIG. 5C and FIG. 5E, a memory allocation constraint 536 may be defined based on a calling relationship junction 538 at target (S1) 522c between calling relationship 526b and calling relationship 526h. Because calling relationship 526b is a shared object-generating relationship 532 and calling relationship 526h is a private object-generating relationship 534, a memory allocation constraint 536 may provide that objects instantiated based on calling relationship 526b and objects instantiated based on calling relationship 526h be instantiated in different memory regions from one another.

As another example, with reference to FIG. 5D and FIG. 5E, a memory allocation constraint 536 may be defined based on a calling relationship junction 538 at target (S2) 522d between calling relationship 526f and calling relationship 526i. Because calling relationship 526i is a shared object-generating relationship 532 and calling relationship 526f is a private object-generating relationship 534, a memory allocation constraint 536 may provide that objects instantiated based on calling relationship 526f and objects instantiated based on calling relationship 526i be instantiated in different memory regions from one another.

As another example, with reference to FIG. 5D and FIG. 5F, a memory allocation constraint 536 may be defined based on a calling relationship junction 538 at target (S3) 522e between calling relationship 526g and calling relationship 526m. Because calling relationship 526m is a shared object-generating relationship 532 and calling relationship 526g is a private object-generating relationship 534, a memory allocation constraint 536 may provide that objects instantiated based on calling relationship 526m and objects instantiated based on calling relationship 526g be instantiated in different memory regions from one another.

### 5. Example Bitmasks for Use in Determining Memory Regions for Instantiating Objects

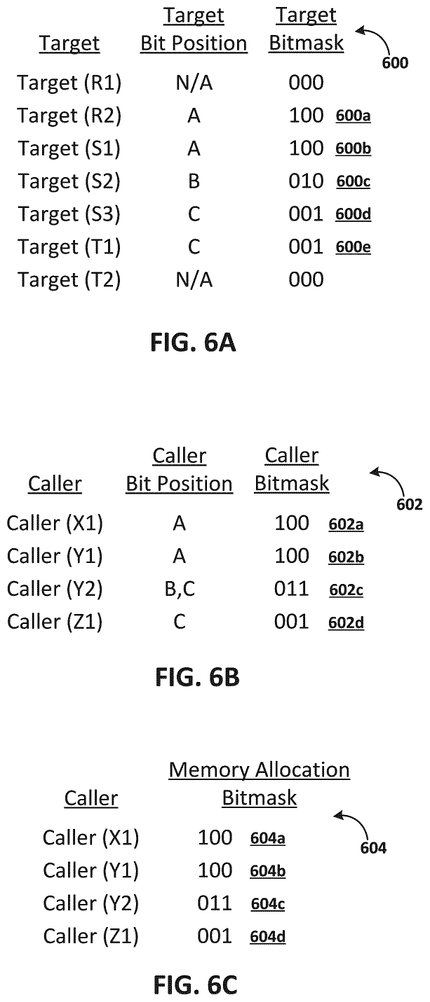

Referring to FIG. 5G and FIGS. 6A-6C, example bitmasks for use in determining memory regions for instantiating objects are further described. The bitmasks include a set of bit positions that are determined based on memory allocation constraints 536 (FIGS. 5C-5F). Example bit positions are described with reference to FIG. 5G. Upon having determined bit positions, for example, as described with reference to FIG. 5G, bitmasks are determined based at least in part on the bit positions. Example bitmasks are described with reference to FIGS. 6A-6C.

As shown in FIG. 5G, a set of target bit positions 540 are determined based on the memory allocation constraints 536. The target bit positions 540 are utilized in target bitmasks as described below with reference to FIG. 6A. Additionally, a set of caller bit positions 542 are determined based on the target bit positions 540. The caller bit positions are utilized in caller bitmasks as described below with reference to FIG. 6B. The caller bitmasks are utilized to populate a memory allocation bitmask as described below with reference to FIG. 6C. As described with reference to FIGS. 6A-6C, to determine a memory region for instantiating an object triggered by a call from a caller to a target, the memory allocation bitmask is populated with a caller bitmask corresponding to the caller and the memory allocation bitmask is compared to a target bitmask corresponding to the target.

FIG. 5G shows calling relationships 526 between callers 520 and targets 522 that are shared object-generating relationships 532. Private object-generating relationships 534 callers 520 and targets 522 are shown in FIGS. 5C-5F. The target bit positions 540 are utilized to indicate whether a call to a target 522 is from a caller 520 that has a shared object-generating relationships 532 with the target 522. The caller bit positions 542 are utilized to indicate whether a call from a caller 520 is to a target 522 that has a shared object-generating relationships 532 with the caller 520. A target bit position 540 is assigned to at least a set of targets 522 that are linked to one or more memory allocation constraints 536. A caller bit position 542 is assigned to at least a set of callers 520 that are linked to one or more targets 522 by a shared object-generating relationships 532.

In one example, a set of targets 522 are assigned different target bit positions 540 with respect to one another when the set of targets 522 are linked to one another by a memory allocation constraint 536. A set of targets 522 are constrained by a memory allocation constraint 536 with respect to one another when the set of targets 522 are linked to one another by the memory allocation constraints 536. Targets 522 that are linked to one another by a memory allocation constraint 536 are assigned different target bit positions 540 relative to one another so that the target bit positions 540 can be utilized to indicate whether a call to a target 522 is from a caller 520 that has a shared object-generating relationship 532 with the target 522. In one example, a first target 522 and a second target 522 are linked to one another by a memory allocation constraint 536 when (a) the first target 522 has a shared object-generating relationship 532 with a first caller 520, and (b) the second target 522 has a private object-generating relationships 534 (FIGS. 5C-5F) with the first caller 520 and a shared object-generating relationship 532 with a second caller 520. When (a) a first target 522 has a shared object-generating relationship 532 with a first caller 520 and (b) a second target 522 has a private object-generating relationship 534 (FIGS. 5C-5F) with the first caller 520 and a shared object-generating relationship 532 with a second caller 520, different target bit positions 540 are utilized for the first target 522 and the second target 522. The different target bit positions 540 are utilized for the first target 522 and the second target 522 to allow the target bit positions 540 to be utilized for determining whether a call is from a caller 520 that has a shared object-generating relationship 532.

In one example, a set of targets 522 may share a target bit position 540 with respect to one another when the set of targets 522 are not linked to one another by a memory allocation constraint 536. A set of targets 522 are unconstrained by the memory allocation constraints 536 with respect to one another when the set of targets 522 are not linked to one another by the memory allocation constraints 536. Targets that are unconstrained with respect to one another by the memory allocation constraints 536 may share a target bit position 540. When a first target 522 and a second target 522 both have a shared object-generating relationship 532 with a first caller 520, the first target 522 and the second target 522 can share a target bit position 540 for determining whether a call is from a caller 520 that has a shared object-generating relationship 532. The first target 522 and the second target 522 can share a target bit position 540 because both the first target 522 and the second target 522 have a shared object-generating relationship 532 with the first caller 520. In one example, even though a first target 522 and a second target 522 are not linked to one another by a first memory allocation constraint 536 associated with a first caller 520, the first target 522 and the second target 522 may be linked to one another by a second memory allocation constraint 536 associated with a second caller 520. The second memory allocation constraint 536 may necessitate different target bit positions 540 for the first target 522 and the second target 522.

As shown in FIG. 5G, the following target bit positions 540 are assigned to the targets 522: target bit position (A) 540b is assigned to target (R2) 522b; target bit position (A) 540c is assigned to target (S1) 522c; target bit position (B) 540d is assigned to target (S2) 522d; target bit position (C) 540e is assigned to target (S3) 522e; target bit position (C) 540f is assigned to target (T1) 522f. Target (R2) 522b and target (S1) 522c can share bit position (A) because target (R2) 522b and target (S1) 522c are not linked to one another by a memory allocation constraint 536. Target (S2) 522d has a different target bit position 540 from target (R2) 522b at least because target (S2) 522d is linked to target (R2) 522b by memory allocation constraint 536a. Target (S2) 522d has a different target bit position 540 from target (S1) 522c at least because target (S2) 522d is linked to target (S1) 522c by memory allocation constraint 536c, memory allocation constraint 536e, and/or memory allocation constraint 536g. Target (S3) 522e has a different target bit position 540 from target (R2) 522b at least because target (S3) 522e is linked to target (R2) 522b by memory allocation constraint 536b. Target (S3) 522e has a different target bit position 540 from target (S1) 522c at least because target (S3) 522e is linked to target (S1) 522c by memory allocation constraint 536d, memory allocation constraint 536f, and/or memory allocation constraint 536h. Target (S3) 522e has a different target bit position 540 from target (S2) 522d at least because target (S2) 522d is linked to target (S3) 522e by memory allocation constraint 536l. Target (T1) 522f and target (S3) 522e can share bit position (C) because target (T1) 522f and target (S3) 522e are not linked to one another by a memory allocation constraint 536. Target (T1) 522f has a different target bit position 540 from target (S1) 522f at least because target (T1) 522f is linked to target (S1) 522c by memory allocation constraint 536m. Target (T1) 522f has a different target bit position 540 from target (S2) 522d at least because target (T1) 522f is linked to target (S2) 522d by memory allocation constraint 536n. Target bit position (A), target bit position (B), and target bit position (C) represent different bit positions of a target bitmask. Target bit position (A) may occupy the same bit position of a target bitmask corresponding to target (R2) and target (S1). Target bit position (C) may occupy the same bit position of a target bitmask corresponding to target (S3) and target (T1).

As shown in FIG. 5G, the following caller bit positions 542 are assigned to the callers 520: caller bit position (A) 542b is assigned to caller (X1) 520a; caller bit position (A) 542c is assigned to caller (Y1) 520b; caller bit position (B) 542d and caller bit position (C) 542e are assigned to caller (Y2) 520c; caller bit position (C) 542f is assigned to caller (Z1) 520n; target bit position (C) 540f is assigned to target (T1) 522f. Caller bit position (A) 542b assigned to caller (X1) 520a corresponds to target bit position (A) 540b of target (R2) 522b and target bit position 540c of target (S1) 522c. Caller bit position (A) 542b is assigned to caller (X1) 520a based on the following: shared object-generating relationships 532a between caller (X1) 520a and target (R2) 522b and shared object-generating relationships 532b between caller (X1) 520a and target (S1) 522c. Caller bit position (A) 542c assigned to caller (Y1) 520b corresponds to target bit position (A) 540c of target (S1) 522c. Caller bit position (A) 542c is assigned to caller (Y1) 520b based on shared object-generating relationships 532e between caller (Y1) 520b and target (S1) 522c. Caller bit position (B) 542d assigned to caller (Y2) 520c corresponds to target bit position (B) 540d of target (S2) 522d. Caller bit position (B) 542d is assigned to caller (Y2) 520c based on shared object-generating relationships 532i between caller (Y2) 520c and target (S2) 522d. Caller bit position (C) 542e assigned to caller (Y2) 520c corresponds to target bit position (C) 540e of target (S3) 522e. Caller bit position (C) 542e is assigned to caller (Y2) 520c based on shared object-generating relationships 532j between caller (Y2) 520c and target (S3) 522e. Caller bit position (C) 542f assigned to caller (Z1) 520n corresponds to target bit position (C) 540e of target (S3) 522e and target bit position (C) 540f of target (T1) 522f. Caller bit position (C) 542e is assigned to caller (Z1) 520n based on the following: shared object-generating relationships 532m between caller (Z1) 520n and target (S3) 522e and shared object-generating relationships 532n between caller (Z1) 520n and target (T1) 522f. Caller bit position (A), caller bit position (B), and caller bit position (C) represent different bit positions of a caller bitmask. Caller bit position (A) may occupy the same bit position of a caller bitmask corresponding to caller (X1) and caller (Y1). Caller bit position (C) may occupy the same bit position of a caller bitmask corresponding to caller (Y2) and caller (Z1).

Referring to FIG. 6A, example target bitmasks 600 are further described. As shown in FIG. 6A, target (R2) and target (S1) are assigned target bit position (A). Based on target bit position (A), target (R2) is assigned target bitmask 600a. Additionally, based on target bit position (A), target (S1) is assigned target bitmask 600b. Target bit position (A) may be a first position of a target bitmask 600. With target bit position (A) being a first position of a target bitmask 600, target bitmask 600a is (100), and target bitmask 600b is (100). Target (S2) is assigned target bit position (B). Based on target bit position (B), target (S2) is assigned target bitmask 600c. Target bit position (B) may be a second position of a target bitmask 600. With target bit position (B) being a second position of a target bitmask 600, target bitmask 600c is (010). Target (S3) and target (T1) are assigned target bit position (C). Based on target bit position (C), target (S3) is assigned target bitmask 600d. Additionally, based on target bit position (C), target (T1) is assigned target bitmask 600e. Target bit position (C) may be a third position of a target bitmask 600. With target bit position (C) being a third position of a target bitmask 600, target bitmask 600d is (001) and target bitmask 600e is (001). As shown in FIG. 6A, target (R1) and target (T2) are not assigned a target bitmask 600, for example, because target (R1) and target (T2) are not part of a shared object-generating relationship 532.

Referring to FIG. 6B, example caller bitmasks 602 are further described. As shown in FIG. 6B, the caller bitmask 602 for a caller is a bitwise complement of the one or more target bitmasks 600 corresponding to the one or more targets that shave a shared object-generating relationship 532 (FIG. 5G) with the caller.

Caller (X1) is assigned caller bit position (A) based (a) on target bit position (A) being assigned to target (R2) and target (S1) and (b) caller (X1) having shared object-generating relationship 532a (FIG. 5G) with target (R2) and shared object-generating relationship 532b (FIG. 5G) with target (S1). Caller (Y1) is assigned caller bit position (A) based on target bit position (A) being assigned to target (S1) and caller (Y1) having shared object-generating relationship 532b (FIG. 5G) with target (S1). Based on caller bit position (A), caller (X1) is assigned caller bitmask 602a. Caller bitmask 602a is a bitwise complement of target bitmask 600a. Additionally, based on caller bit position (A), caller (Y1) is assigned caller bitmask 602b. Caller bitmask 602b is a bitwise complement of target bitmask 600b. With target bit position (A) being a first bit position of a target bitmask 600 (FIG. 6A), caller bit position (A) is a first bit position of a caller bitmask 602. With caller bit position (A) being a first position of a caller bitmask 602, caller bitmask 602a is (100) and caller bitmask 602b is (100).

Caller (Y2) is assigned caller bit position (B) based on target bit position (B) being assigned to target (S2) and caller (Y2) having shared object-generating relationship 532i (FIG. 5G) with target (S2). Additionally, caller (2) is assigned caller bit position (C) based on target bit position (C) being assigned to target (S3) and caller (Y2) having shared object-generating relationship 532j (FIG. 5G) with target (S3). Based on caller bit position (B) and caller bit position (C), caller (Y2) is assigned caller bitmask 602c. caller bit position (B) and caller bit position (C) are located at a different bit sequence index relative to one another. Caller bitmask 602c is a bitwise complement of target bitmask 600c and target bitmask 600d. With target bit position (B) being a second position of a target bitmask 600 (FIG. 6A), caller bit position (B) is a second bit position of a caller bitmask 602. The bit sequence index of caller bit position (B) may match the bit sequence index of target bit position (B). With target bit position (C) being a third position of a target bitmask 600 (FIG. 6A), caller bit position (C) is a third bit position of a caller bitmask 602. The bit sequence index of caller bit position (C) may match the bit sequence index of target bit position (C). With caller bit position (B) being a second position of a caller bitmask 602 and caller bit position (C) being a third position of a caller bitmask 602, caller bitmask 602c is (011).

Caller (Z1) is assigned caller bit position (C) based (a) on target bit position (C) being assigned to target (S3) and target (T1) and (b) caller (Z1) having shared object-generating relationship 532m (FIG. 5G) with target (S3) and shared object-generating relationship 532n (FIG. 5G) with target (T1). Based on caller bit position (C), caller (Z1) is assigned caller bitmask 602d. Caller bitmask 602d is a bitwise complement of target bitmask 600e. With target bit position (C) being a third bit position of a target bitmask 600 (FIG. 6A), caller bit position (C) is a third bit position of a caller bitmask 602. With caller bit position (C) being a third position of a caller bitmask 602, caller bitmask 602d is (001).

Referring to FIG. 6C, example memory allocation bitmasks 604 are further described. When a caller initiates a call to a target, a memory allocation bitmask 604 is populated with a caller bitmask corresponding to the caller. The memory allocation bitmask 604 is a bitwise complement of the caller bitmask corresponding to the caller. The memory allocation bitmask 604 may be a thread local variable. The memory allocation bitmask 604 is compared to a target bitmask corresponding to the target of the call to determine a memory region for instantiating objects triggered by the call.

When caller (X1) initiates a call to a target, the memory allocation bitmask 604 is populated with caller bitmask 602a to provide memory allocation bitmask 604a. Based on caller bitmask 602a being (100), memory allocation bitmask 604a is (100) upon having been populated with caller bitmask 602a. When caller (Y1) initiates a call to a target, the memory allocation bitmask 604 is populated with caller bitmask 602b to provide memory allocation bitmask 604b. Based on caller bitmask 602b being (100), memory allocation bitmask 604b is (100) upon having been populated with caller bitmask 602b. When caller (Y2) initiates a call to a target, the memory allocation bitmask 604 is populated with caller bitmask 602c to provide memory allocation bitmask 604c. Based on caller bitmask 602c being (011), memory allocation bitmask 604c is (011) upon having been populated with caller bitmask 602c. When caller (Z1) initiates a call to a target, the memory allocation bitmask 604 is populated with caller bitmask 602d to provide memory allocation bitmask 604d. Based on caller bitmask 602d being (001), memory allocation bitmask 604d is (001) upon having been populated with caller bitmask 602d.

A memory region for instantiating objects triggered by a call from a caller to a target is determined based on a comparison of the target bitmask, assigned to the target, to the memory allocation bitmask, as populated by the caller bitmask assigned to the caller. In one example, the comparison includes a bitwise AND operation.

The bitwise AND operation is performed using an AND logical operator that returns true (or 1) only if both corresponding bits of an operands are true (or 1). The bitwise AND operation compares corresponding bits of the memory allocation bitmask and the target bitmask and produces a binary number, where each bit is the result of the AND operation of the corresponding bits of the memory allocation bitmasks and the target bitmask. In one example, a shared memory region is selected when the bitwise AND operation is non-zero. In one example, a private memory region is selected when the bitwise AND operation is zero. The private memory region may be a thread-local memory region.

In one example, for a call from caller (X1) to target (R2), the memory allocation bitmask 604 is populated with caller bitmask 602a to provide memory allocation bitmask 604a. Target bitmask 600a assigned to target (R2) is compared to memory allocation bitmask 604a using a bitwise AND operation. Memory allocation bitmask 604a is (100). Target bitmask 600a is (100). The bitwise AND operation comparing memory allocation bitmask 604a (100) to target bitmask 600a (100) returns a result of (100). Based on the result of the bitwise AND operation being non-zero, a shared memory region is selected for instantiating objects triggered by the call from caller (X1) to target (R2). As shown in FIG. 5C, calling relationship 526a between caller (X1) 520a and target (R2) 522b is a shared object-generating relationships 532.

In one example, for a call from caller (Y1) to target (S2), the memory allocation bitmask 604 is populated with caller bitmask 602b to provide memory allocation bitmask 604b. Target bitmask 600c assigned to target (S2) is compared to memory allocation bitmask 604b using a bitwise AND operation. Memory allocation bitmask 604b is (100). Target bitmask 600c is (010). The bitwise AND operation comparing memory allocation bitmask 604b (100) to target bitmask 600c (010) returns a result of (000). Based on the result of the bitwise AND operation being zero, a private memory region, such as a thread-local memory region, is selected for instantiating objects triggered by the call from caller (Y1) to target (S2). As shown in FIG. 5D, calling relationship 526f between caller (Y1) 520b and target (S2) 522d is a private object-generating relationships 534.

In one example, for a call from caller (Y2) to target (S2), the memory allocation bitmask 604 is populated with caller bitmask 602c to provide memory allocation bitmask 604c. Target bitmask 600c assigned to target (S2) is compared to memory allocation bitmask 604c using a bitwise AND operation. Memory allocation bitmask 604c is (011). Target bitmask 600c is (010). The bitwise AND operation comparing memory allocation bitmask 604c (011) to target bitmask 600c (010) returns a result of (010). Based on the result of the bitwise AND operation being non-zero, a shared memory region is selected for instantiating objects triggered by the call from caller (Y2) to target (S2). As shown in FIG. 5E, calling relationship 526i between caller (Y2) 520c and target (S2) 522d is a shared object-generating relationships 532.

In one example, for a call from caller (Z1) to target (S2), the memory allocation bitmask 604 is populated with caller bitmask 602d to provide memory allocation bitmask 604d. Target bitmask 600c assigned to target (S2) is compared to memory allocation bitmask 604d using a bitwise AND operation. Memory allocation bitmask 604d is (001). Target bitmask 600c is (010). The bitwise AND operation comparing memory allocation bitmask 604d (001) to target bitmask 600c (010) returns a result of (000). Based on the result of the bitwise AND operation being zero, a private memory region, such as a thread-local memory region, is selected for instantiating objects triggered by the call from caller (Y2) to target (S2). As shown in FIG. 5F, calling relationship 526l between caller (Z1) 520n and target (S2) 522d is a private object-generating relationships 534.

### 6. Example Operations Pertaining to Determining Memory Regions for Instantiating Objects in Accordance with Memory Allocation Constraints

Referring now to FIGS. 7A-7G, operations 700 pertaining to determining memory regions for instantiating objects in accordance with memory allocation constraints are further described. One or more operations 700 described with reference to FIGS. 7A-7G may be executed using one or more components of the computing architecture described with reference to FIGS. 1-4. Additionally, or alternatively, one or more operations 700 described with reference to FIGS. 7A-7G may be executed in connection with one or more callers and one or more targets described with reference to FIGS. 5A-5G. Additionally, or alternatively, one or more operations 700 described with reference to FIGS. 7A-7G may be executed utilizing one or more bitmasks described with reference to FIGS. 6A-6C. One or more operations 700 described with reference to FIGS. 7A-7G may be modified, combined, rearranged, or omitted. Accordingly, the particular sequence of operations 700 described with reference to FIGS. 7A-7G should not be construed as limiting the scope of one or more embodiments.

Referring to FIG. 7A, a system determines memory regions for instantiating objects in accordance with memory allocation constraints. As shown in FIG. 7A, the system determines a set of constraint inputs for defining memory allocation constraints for a set of calling relationships (Operation 702). The calling relationships represent a call that can be made from a caller to a target. Operations 700 pertaining to determining constraint inputs for defining memory allocation constraints for calling relationships are further described with reference to FIG. 7B.

Based on the set of constraint inputs, the system defines a set of memory allocation constraints for the set of calling relationships (Operation 704). The memory allocation constraints may include constraints on the memory regions that the system can utilize when instantiating objects in response to different calling relationships. The memory allocation constraints may require that objects instantiated based on shared object-generating relationships and objects instantiated based on private object-generating relationships be instantiated in different memory regions from one another. Operations 700 pertaining to defining memory allocation constraints are further described with reference to FIG. 7C.

Upon having defined a set of memory allocation constraints, the system executes a process for configuring a memory allocation bitmask for designating memory regions for instantiating objects in accordance with the memory allocation constraints (Operation 706). In one example, the process for configuring the memory allocation bitmask includes configuring target bit positions of a set of target bitmasks assigned to a set of targets of the calling relationships based on the memory allocation constraints. Additionally, the process for configuring the memory allocation bitmask may include configuring caller bit positions of a set of caller bitmasks assigned to a set of callers of the calling relationships based on the target bitmasks. Additionally, the process for configuring the memory allocation bitmask may include storing the set of caller bitmasks for populating the memory allocation bitmask, in response to a call from a caller to a target, with a caller bitmask corresponding to the caller. Additionally, the process for configuring the memory allocation bitmask may include storing the set of target bitmasks for comparing the memory allocation bitmask to a target bitmasks associated with the target to determine a memory region for instantiating an object in response to the call from the caller to the target. Operations 700 pertaining to the process for configuring the memory allocation bitmask, including operations 700 pertaining to configuring the target bitmasks and caller bitmasks, are further described with reference to FIGS. 7D-7F. Upon having executed the process for configuring the memory allocation bitmask, the system utilizes the memory allocation bitmask to designate memory regions for instantiating objects in accordance with the memory allocation constraints (Operation 708). Operations 700 pertaining to determining memory regions for instantiating objects are further described with reference to FIG. 7G.

### 6.1 Determining Constraint Inputs for Defining Memory Allocation Constraints

Referring to FIG. 7B, operations 700 pertaining to determining constraint inputs for defining memory allocation constraints are further described. The constraint inputs are defined for a set of calling relationships that include a call from a caller to a target. As shown in FIG. 7B, to determine constraint inputs for defining memory allocation constraints, the system determines a set of calling relationships between a set of callers and a set of targets (Operation 710). The system may generate a data structure, such as a call graph and/or a data repository, that identifies the calling relationships that are determined by the system. The calling relationships include shared object-generating relationships between callers and targets. Additionally, or alternatively, the calling relationships include private object-generating relationships between callers and targets.

In one example, the system determines the set of calling relationships based on a static analysis that is performed without executing code. The system may parse code using a static analysis tool. Additionally, or alternatively, the system may construct a call graph that represents calling relationships between callers and targets. The system may traverse the call graph to identify callers and targets. Upon identifying callers and targets in the call graph, the system may determine whether the calling relationships are shared object-generating relationships or private object-generating relationships by extracting information from the parsed code and/or from the call graph corresponding to the callers and the targets.

In one example, the system determines the set of calling relationships based on a dynamic analysis that is performed while executing code. The dynamic analysis may be performed in a production environment and/or in a testing environment. The system may utilize a logger or profiling tool to track calls at runtime. Additionally, or alternatively, the system may track instructions to instantiate an object in response to calls at runtime to determine whether the objects are shared objects or private objects. The instructions to instantiate an object may be tracked at a load barrier or a store barrier.

Upon having determined the set of calling relationships, the system selects a calling relationship between a caller and a target (Operation 712). The system may select the calling relationship based on one or more of the following: order of occurrence, frequency of occurrence, complexity, importance, dependency, or recency of changes. The system may select the calling relationship based on a topological order, for example, according to a call graph. Additionally, or alternatively, the system may select the calling relationship based on a breadth-first search of the call graph or a depth-first search of the call graph. The system may utilize static call counts and/or runtime profiling data to prioritize the calling relationships based on how frequently the calling relationships are executed. Additionally, or alternatively, the system may prioritize the calling relationships based on a cyclomatic complexity metric. The cyclomatic complexity metric may represent, for a particular calling relationship, a number of independent paths through the source code that encounter the calling relationship. Additionally, or alternatively, the system may prioritize the calling relationships based on a number of calling relationships that are linked by a common caller and/or by a common target.

Upon selecting the calling relationship, the system ascertains whether the calling relationship has been designated as being capable of triggering the target of the calling relationship to instantiate a shared object (Operation 714). The system may reference metadata associated with the calling relationship that indicates whether the calling relationship has been designated as being capable of triggering the target of the calling relationship to instantiate a shared object. In one example, the metadata may include a bitmask associated with the caller and/or the target of the calling relationship that indicates whether the calling relationship has been designated as being capable of triggering the target of the calling relationship to instantiate a shared object. When the system determines that a calling relationship is capable of triggering the target of the calling relationship to instantiate a shared object, the system may set a bit of the bitmask, for example, to a value of (1). Subsequently, the system may refer to the bitmask, and upon determining that the bit of the bitmask has a value of (1), the system may determine that the calling relationship has been designated as being capable of triggering the target of the calling relationship to instantiate a shared object. Additionally, or alternatively, when the bit of the bitmask has a value of (0), the system may determine that the calling relationship has not been designated as being capable of triggering the target of the calling relationship to instantiate a shared object.

Additionally, or alternatively, the system may reference a calling relationship data repository that includes a set of calling relationships and an indication as to whether the calling relationship has been designated as being capable of triggering the target of the calling relationship to instantiate a shared object. When the system determines that a calling relationship is capable of triggering the target of the calling relationship to instantiate a shared object, the system may update the calling relationship data repository to indicate that the calling relationship is capable of triggering the target of the calling relationship to instantiate a shared object. Subsequently, the system may refer to the calling relationship data repository, and based on the calling relationship data repository, the system may determine whether the calling relationship has been designated as being capable of triggering the target of the calling relationship to instantiate a shared object.

In one example, the system presumes that a calling relationship does not trigger the target of the calling relationship to instantiate a shared object unless and/or until the system detects at least one occurrence of the target of the calling relationship instantiating a shared object. The bit of the bitmask and/or the calling relationship data repository may indicate that a calling relationship does not trigger the target of the calling relationship to instantiate a shared object unless and/or until the system detects at least one occurrence of the target of the calling relationship instantiating a shared object.

The system may determine whether a calling relationship is capable of triggering the target of the calling relationship to instantiate a shared object based on one or more occurrence of a call from the caller of the calling relationship to the target of the calling relationship that triggers the target to instantiate a shared object. The one or more occurrences of a call triggering the target to instantiate a shared object may be determined based on a static analysis that is performed without executing code and/or based on a dynamic analysis that is performed while executing code. The dynamic analysis may be performed in a production environment and/or in a testing environment.

In one example, a calling relationship is considered capable of triggering the target of the calling relationship to instantiate a shared object when at least one call from the caller to the target of the calling relationship triggers the target to instantiate a shared object. Some calls from the caller to the target may trigger the target to generate private objects, while other calls from the caller to the target may trigger the target to generate shared objects. In one example, a calling relationship is considered capable of triggering the target of the calling relationship to instantiate a shared object when a proportion of calls from the caller to the target of the calling relationship trigger the target to instantiate a shared object meets a threshold.

In one example, the system may interrogate store operations at a store barrier when storing an object and/or when storing a pointer to an object. The system may interrogate store operations that are triggered by the target of the calling relationship to determine whether the store operation includes storing a shared object or a private object and/or to determine whether the store operation includes storing a pointer to a shared object or a private object. Additionally, or alternatively, the system may interrogate a store operation to determine whether the store operation is triggered by the target of the calling relationship.

In one example, the system may interrogate load operations at a load barrier when loading a pointer that points to an object and/or when loading the object. The system may interrogate load operations to determine whether objects that are loaded by the load operations are shared objects or private objects. Additionally, the system may interrogate load operations to determine whether objects that are loaded by the load operations were instantiated by a target of the calling relationship.

When the system determines that the calling relationship has been designated as being capable of triggering the target to instantiate a shared object, the system defines a constraint input that identifies the calling relationship as a shared object-generating calling relationship (Operation 716). By defining the constraint input that identifies the calling relationship as a shared object-generating calling relationship, the system flags the calling relationship for use in defining memory allocation constraints based at least in part on the calling relationship being a shared object-generating calling relationship. Additionally, or alternatively, when the system determines that the calling relationship has not been designated as being capable of triggering the target to instantiate a shared object, the system defines a constraint input that identifies the calling relationship as a private object-generating calling relationship (Operation 718). By defining the constraint input that identifies the calling relationship as a private object-generating calling relationship, the system flags the calling relationship for use in defining memory allocation constraints based at least in part on the calling relationship being a private object-generating calling relationship.

The system may define the constraint input at operation 716 and/or at operation 718 by storing the constraint input in a constraint input repository. The constraint input repository may include a set of calling relationships and an indication as to whether the calling relationships are shared object-generating calling relationship or private object-generating calling relationship. In one example, the system may configure the constraint input repository as a constraint graph. The system may generate nodes that represent callers and targets, as well as edges that represent calling relationships between the callers and targets. The system labels the edges to indicate whether the calling relationships represented by the edges are shared object-generating calling relationships or private object-generating calling relationships. Additionally, or alternatively, the system may configure the constraint input repository as a relational table that identifies calling relationships, including the callers and targets of the calling relationships, and that indicates whether the calling relationships are shared object-generating calling relationships or private object-generating calling relationships.

Upon having defined the constraint input at operation 716 or operation 718, the system determines whether the set of calling relationships include an additional calling relationship (Operation 720). When the system determines that the set of calling relationships include an additional calling relationship, the system selects the additional calling relationship (Operation 722) and returns to operation 714 to determine whether the additional calling relationship has been designated as being capable of trigging the target of the calling relationship to instantiate a shared object. The operations 700 pertaining to determining constraint inputs for defining memory allocation constraints may end when the system determines that the set of calling relationships does not include an additional calling relationship.

### 6.2 Defining Memory Allocation Constraints for Calling Relationships

Referring to FIG. 7C, operations 700 pertaining to defining memory allocation constraints are further described. The system defines the memory allocation constraints based on constraint inputs determined for calling relationships, for example, as described with reference to FIG. 7B. In one example, the system defines memory allocation constraints that provide for different memory regions to be utilized for instantiating objects as between objects instantiated based on shared object-generating relationships and objects instantiated based on private object-generating relationships. In one example, the system defines the memory allocation constraints for sets of calling relationships that have a calling relationship junction. A first calling relationship and a second calling relationship have a calling relationship junction when the first calling relationship and the second calling relationship share a caller or a target. The system defines a memory allocation constraint when the calling relationship junction includes a shared object-generating relationship and a private object-generating relationship. For example, the system defines a memory allocation constraint when the first calling relationship of the calling relationship junction is a shared object-generating relationship, and the second calling relationship of the calling relationship junction is a private object-generating relationship. As described with reference to FIG. 7B, a calling relationship may be designated a shared object-generating relationship when the calling relationship is capable of triggering a target of the calling relationship to instantiate a shared object. As further described with reference to FIG. 7B, a calling relationship may be designated a private object-generating relationship when the calling relationship has yet to trigger the target to instantiate a shared object. When the calling relationship junction includes a shared object-generating relationship and a private object-generating relationship, the system defines a memory allocation constraint that requires the calling relationships of the calling relationship junction to utilize different memory allocations from one another for instantiating objects in response to calls associated with the respective calling relationships of the calling relationship junction.

As shown in FIG. 7C, the system determines, based on a set of calling relationships, a set of a calling relationships junctions (Operation 726). The calling relationship junctions represent sets of calling relationships that share a caller or a target. The system may generate a data structure, such as a call graph and/or a data repository, that identifies the calling relationship junctions that are determined by the system. The system may determine the calling relationship junctions as and when the system determines the calling relationships at operation 710 (FIG. 7B). For example, as and when the system determines calling relationships that share a caller or a target, the system may include, in a data structure that identifies the calling relationships, an indication of calling relationship junctions between the calling relationships. The system may determine the set of calling relationship junctions based on a static analysis and/or a dynamic analysis. Additionally, or alternatively, the system may identify calling relationship junctions by evaluating a data structure that defines a set of calling relationships to identify calling relationships in the data structure that share a caller or a target.

Upon having determined the set of calling relationship junctions, the system selects a calling relationship junction from the set of calling relationship junctions (Operation 728). The system may select the calling relationship junction based on one or more of the following: order of occurrence, frequency of occurrence, complexity, importance, dependency, or recency of changes. The system may select the calling relationship junction based on a topological order, for example, according to a call graph. Additionally, or alternatively, the system may select the calling relationship junction based on a breadth-first search of the call graph or a depth-first search of the call graph. The system may utilize static call counts and/or runtime profiling data to prioritize the calling relationship junctions based on how frequently the one or more calling relationships of the calling relationship junction are executed. Additionally, or alternatively, the system may prioritize the calling relationship junctions based on a cyclomatic complexity metric. The cyclomatic complexity metric may represent, for a particular calling relationship junction, a number of independent paths through the source code that encounter the calling relationship junction. Additionally, or alternatively, the system may prioritize the calling relationship junctions based on a number of calling relationships that are linked to the calling relationship junction by a common caller and/or by a common target.

Upon selecting the calling relationship, the system determines a set of constraint inputs defined for the calling relationships of the calling relationship junction (Operation 730). The constraint inputs may include destinations of calling relationships that are capable of triggering a target to instantiate a shared object as shared object-generating relationships. Additionally, or alternatively, the constraints inputs may include destinations of calling relationships that have yet to trigger a target to instantiate a shared object as private object-generating relationships. The system may determine the set of constraint inputs from a constraint input repository. The system may identify a set of calling relationships corresponding to the calling relationship junction, and based on the set of calling relationships, the system may identify constraint inputs associated with the calling relationships. In one example, the system determines a first constraint input associated with a first calling relationship of a calling relationship junction and a second constraint input associated with a second call relationship of the call relationship junction.

Upon having determined the set of constraint inputs defined for the calling relationships of the calling relationship junction, the system determines whether the set of constraint inputs defined for the calling relationships of the calling relationship junction satisfy a set of criteria for defining a memory allocation constraint for the calling relationships of the calling relationship junction (Operation 732). In one example, the set of criteria for defining a memory allocation constraint may include a determination that the constraint inputs for the calling relationships of the calling relationship junction include: (a) a first constraint input that designates a first calling relationship as being capable of triggering a target to instantiate a shared object and (b) a second constraint input that designates a second calling relationship as having yet to trigger a target to instantiate a shared object. For example, the first constraint input may designate the first calling relationship of the calling relationship junction as a shared object-generating relationship, and the second constraint input may designate the second calling relationship as a private object-generating relationship.

When the system determines that the set of criteria is satisfied for defining a memory allocation constraint for the calling relationships of the calling relationship junction, the system defines a memory allocation constraint for the calling relationships of the calling relationship junction (Operation 734). The memory allocation constraint provides that the first calling relationship and the second calling relationship of the calling relationship junction utilize different memory regions from one another for instantiating objects in response to calls associated with the respective calling relationships. In one example, the memory allocation constraint provides that a first memory region is utilized for instantiating objects in response to calls according to the first calling relationship and that a second memory region is utilized for instantiating objects in response to calls according to the second calling relationship. In one example, the first calling relationship is a shared object-generating relationship, and the first memory region is a shared memory region. Additionally, or alternatively, the second calling is a private object-generating relationship, and the second memory region is a private memory region, such as a thread-local memory region.

In one example, the system defines the memory allocation constraint in a data structure, such as a constraint graph or a memory allocation constraint repository. In one example, the system may augment a data structure that includes constraint inputs to define the memory allocation constraint based on the constraint inputs. The system may generate an edge in the constraint graph that represents the memory allocation constraint. Additionally, or alternatively, the system may configure the memory allocation constraint repository as a relational table. The system may add an entry to the memory allocation constraint repository that identifies the memory allocation constraint. The system may generate the memory allocation constraint repository by adding the memory allocation constraint to the constraint input repository. Additionally, or alternatively, the memory allocation constraint repository may be linked to the constraint input repository.

Upon having defined the memory allocation constraint, the system determines whether the set of calling relationship junctions include an additional calling relationship junction (Operation 736). Additionally, or alternatively, the system may determine whether the set of calling relationship junctions include an additional calling relationship junction in response to determining, at operation 732, that the set of criteria is unmet for defining a memory allocation constraint for the calling relationships of the calling relationship junction. When the set of calling relationship junctions include an additional calling relationship junction, the system selects the additional calling relationship junction (Operation 738) and returns to operation 730 to determine a set of constraint inputs defined for the calling relationships of the additional calling relationship junction. The operations 700 pertaining to defining memory allocation constraints may end when the system determines that the set of calling relationship junctions does not include an additional calling relationship junction.

### 6.3 Configuring Bitmasks for Use in Designating Memory Regions for Instantiating Objects

Referring to FIG. 7D, operations 700 pertaining to configuring a set of bitmasks for use in determining memory regions for instantiating objects in accordance with the memory allocation constraints are further described. The set of bitmasks include target bitmasks associated with targets and caller bitmasks associated with callers. Additionally, the set of bitmasks may include one or more memory allocation bitmasks that are populated by caller bitmasks corresponding to calls from callers that trigger targets to instantiate objects.

As shown in FIG. 7D, the system determines a set of memory allocation constraints that are defined for a set of calling relationships (Operation 742). The set of memory allocation constraints may be defined for the set of calling relationships as described with reference to FIG. 7C. Upon determining the set of memory allocation constraints that are defined for a set of calling relationships, the system determines a set of targets associated with the set of memory allocation constraints (Operation 744). The system may determine the set of targets associated with the set of memory allocation constraints by referencing a data structure that includes the set of targets associated with the set of memory allocation constraints, such as a constraint graph or a memory allocation constraint repository.

Upon determining the set of targets associated with the set of memory allocation constraints, the system assigns a set of target bit positions to a set of target bitmasks associated with the set of targets (Operation 746). The system may utilize bitwise operators to generate the target bitmasks and assign target bit positions to the target bitmasks. The target bit positions are assigned to the set of target bitmasks based on the set of memory allocation constraints. The system may utilize one or more graph coloring algorithms to assign target bit positions to the set of target bitmasks. The one or more graph coloring algorithms may include one or more of the following: an exact algorithm, such as an algorithm that utilizes a backtracking methodology or a branch and bound methodology to assign target bit positions; a heuristic algorithm, such as an algorithm that assigns target bit positions based on the smallest available target bit position and/or based on the number of adjacent targets that have different bit positions; or an approximation algorithm, such as an algorithm that utilizes a polynomial-time factor to determine an optimal number of target bit positions. Operations 700 pertaining to assigning target bit positions to target bitmasks are further described with reference to FIG. 7E.

Upon assigning the target bit positions to the target bitmasks, the system stores the set of target bitmasks for use in determining memory regions for instantiating objects in response to calls corresponding to different calling relationships (Operation 748). In one example, the system stores the target bitmasks in variables that are mapped to the corresponding targets. Additionally, or alternatively, the system may store the target bitmasks in a bitmask repository that includes the set of targets and the target bitmasks with the target bitmasks mapped to the corresponding targets.

Upon assigning the target bit positions to the target bitmasks and/or upon storing the set of target bitmasks, the system determines a set of callers associated with the set of memory allocation constraints (Operation 750). The system may determine the set of callers associated with the set of memory allocation constraints by referencing a data structure that includes the set of callers associated with the set of memory allocation constraints, such as a constraint graph or a memory allocation constraint repository.

Upon determining the set of callers associated with the set of memory allocation constraints, the system assigns a set of caller bit positions to a set of caller bitmasks associated with the set of callers (Operation 752). The caller bit positions are assigned to the set of caller bitmasks based on the target bit positions assigned to the set of target bitmasks. In one example, a caller bitmask associated with a caller is a bitwise complement of a set of one or more target bitmasks associated with one or more targets that have a calling relationship with the caller. The system may utilize bitwise operators to generate the caller bitmasks and assign caller bit positions to the caller bitmasks. Operations 700 pertaining to assigning caller bit positions to caller bitmasks are further described with reference to FIG. 7F. Upon assigning the caller bit positions to the caller bitmasks, the system stores the set of caller bitmasks for use in determining memory regions for instantiating objects in response to calls corresponding to different calling relationships (Operation 754). In one example, the system stores the caller bitmasks in variables that are mapped to the corresponding callers. Additionally, or alternatively, the system may store the caller bitmasks in a bitmask repository that includes the set of callers and the caller bitmasks with the caller bitmasks mapped to the corresponding callers.

The target bitmasks and the caller bitmask may be utilized for determining memory regions for instantiating objects in response to calls from callers associated with the caller bitmasks to targets associated with the target bitmasks. Operations 700 pertaining to determining memory regions for instantiating objects are further described with reference to FIG. 7G.

Referring to FIG. 7E, operations 700 pertaining to assigning target bit positions to target bitmasks are further described. The system may execute or more operations 700 described with reference to FIG. 7E to assign target bit positions to target bitmasks at operation 746 (FIG. 7D). The system may utilize one or more graph coloring algorithms to execute one or more of the operations 700 described with reference to FIG. 7E.

As shown in FIG. 7E, the system selects a target from the set of targets associated with the set of memory allocation constraints (Operation 756). The system may select the target from a constraint graph. The system may select the target based on one or more of the following: arbitrary ordering, sequential ordering, or number of calling relationships associated with the target. Upon selecting the target, the system determines a set of adjacent targets (Operation 758). The adjacent targets are targets that are linked with the target by one or more memory allocation constraints. The system may determine the set of adjacent targets based on the constraint graph. Additionally, or alternatively, the system may generate an adjacency list that includes a set of adjacent targets for the target.

Upon determining the set of adjacent targets that are linked with the target by the one or more memory allocation constraints, the system selects a next available target bit position (Operation 760). The next available target bit position is a bit position that has not been assigned to a target bitmask of an adjacent target. When the system determines that a target bit position has already been assigned to a target bitmask of an adjacent target, the system proceeds to a next target bit position until the system identifies the next available target bit position. The system assigns target bit positions according to a rule that adjacent targets are assigned different target bit positions from one another. Additionally, or alternatively, adjacent targets cannot have the same target bit position. Targets that are not adjacent may have the same target bit position. Adjacent targets cannot have the same target bit position because the target bit positions are utilized to determine memory regions for instantiating objects in response to calls to the targets, and the memory allocation constraints require that adjacent targets instantiate objects in different memory regions from one another. By requiring that adjacent targets have different target bit positions, the memory regions that are assigned by the system adhere to the memory allocation constraints. When the system determines that the selected target bit position has not been assigned to a target bitmask associated with an adjacent target, the system assigns the selected target bit position to a target bitmask associated with the target (Operation 762). The system may utilize the same target bit position for targets that are not adjacent because targets that are not adjacent may instantiate objects in the same memory region without violating a memory allocation constraint.

Upon assigning the selected target bit position to the target bitmask associated with the target, the system determines whether the set of targets include a target that does not have a target bit position assigned to a target bitmask associated with the target (Operation 764). When the system determines that the set of targets includes a target that does not have a target bit position assigned to a target bitmask associated with the target, the system returns to operation 756 to select the target for assigning a target bit positions. In one example, the operations 700 pertaining to assigning target bit positions to target bitmasks may end when the system determines that that target bit positions have been assigned to the set of target bitmasks associated with the set of targets. Alternatively, in one example, upon determining that target bit positions have been assigned to the set of target bitmasks associated with the set of targets, the system may validate that the target bit positions assigned to the target bitmasks for adjacent targets are different from one another (Operation 766). The system may validate that the target bit positions assigned to the target bitmasks for adjacent targets are different from one another by checking the target bit positions assigned to the target bitmasks for adjacent targets to determine whether the adjacent targets have different target bit positions. The system may backtrack or re-assign target bit positions to the target bitmasks for one or more adjacent targets in the event that the system identifies target bitmask for adjacent targets that have the same target bit position.

Referring to FIG. 7F, operations 700 pertaining to assigning caller bit positions to caller bitmasks are further described. The system may execute one or more operations 700 described with reference to FIG. 7F to assign caller bit positions to caller bitmasks at operation 752 (FIG. 7D).

As shown in FIG. 7F, the system selects a caller from the set of callers associated with the set of memory allocation constraints (Operation 770). The system may select the caller from a constraint graph. The system may select the caller based on one or more of the following: arbitrary ordering, sequential ordering, or number of calling relationships associated with the target. Upon selecting the caller, the system determines a target related to the caller by a calling relationship (Operation 772). The system may determine the target based on the constraint graph.

Upon determining the target related to the caller by the calling relationship, the system determines whether the target is associated with a target bitmask that has a target bit position assigned to the target bitmask for determining a memory region for instantiating objects in response to calls to the target (Operation 774). When the system determines that the target is associated with a target bitmask that has a target bit position assigned to the target bitmask for determining a memory region for instantiating objects in response to calls to the target, the system assigns a caller bit position to a caller bitmask associated with the caller (Operation 776). The caller bitmasks may be a bitwise complement of the target bitmask associated with the target.

Upon assigning the caller bit position to the caller bitmask associated with the caller, the system determines whether the caller is related to an additional target (Operation 778). When the system determines that the caller is related to another target, the system returns to operation 774. At operation 774, the system determines whether the target is associated with a target bitmask that has a target bit position assigned to the target bitmask for determining a memory region for instantiating objects in response to calls to the target. When the system determines that the caller is not related to another target, the system determines whether the set of callers includes an additional caller that has not yet been assigned a caller bit position (Operation 780). When the system determines that the set of callers includes an additional caller, the system returns to operation 770.

In one example, the operations 700 pertaining to assigning caller bit positions to caller bitmasks may end when the system determines that the set of callers have been assigned caller bit positions. Alternatively, in one example, upon determining that the set of callers have been assigned caller bit positions, the system may validate that the caller bitmasks have been assigned caller bit positions that are bitwise complements of target bit positions of target bitmasks associated with related targets (Operation 782). The system may validate that the caller bitmasks have been assigned caller bit positions that are bitwise complements of target bit positions of target bitmasks associated with related targets by checking the target bit positions assigned to the target bitmasks for related targets and comparing the target bit positions to the caller bit positions to determine whether the target bit positions match the caller bit positions. The system may backtrack or re-assign caller bit positions to the caller bitmasks for one or more callers if the system identifies a caller bitmask that includes a caller bit position that is not a bitwise complement of a target bit position of a target bitmask associated with a related target.

### 6.4 Utilizing Bitmasks to Designate Memory Regions for Instantiating Objects

Referring to FIG. 7G, operations 700 pertaining to determining memory regions for instantiating objects are further described. As shown in FIG. 7G, the system detects a call from a caller to a target that includes an instruction that triggers the target to instantiate an object (Operation 786). The system may detect a call from a caller to a target that includes an instruction that triggers the target to instantiate an object by tracking operations at a load barrier and/or at a store barrier. Additionally, or alternatively, the system may utilize one or more of the following to detect a call from a caller to a target that includes an instruction that triggers the target to instantiate an object: event hooks, contextual flags, interceptors, or filters.

Upon detecting the call from the caller to the target, the system populates a memory allocation bitmasks with a caller bitmask associated with the caller (Operation 788). The system may utilize a bitwise operator to access the caller bitmask and populate the memory allocation with the caller bitmask. Additionally, the system selects a target bitmask associated with the target for comparison to the memory allocation bitmask (Operation 790).

Upon populating the memory allocation bitmask with the caller bitmask associated with the caller and selecting the target bitmask associated with the target, the system executes a comparison of the target bitmask to the memory allocation bitmask (Operation 792). The system may utilize one or more bitwise operators to compare the target bitmask to the memory allocation bitmask. The comparison may include a bitwise AND operation between the target bitmask and the memory allocation bitmask populated with the caller bitmask.

Upon executing the comparison of the target bitmask to the memory allocation bitmask, the system determines whether the comparison indicates to instantiate the object in a first memory region (Operation 794). In one example, the comparison may indicate to instantiate the object either in a first memory region or a second memory region. When the comparison indicates to instantiate the object in a first memory region, the system selects the first memory region for the target to instantiate the object (Operation 796). The system may generate a reference or pointer to the first memory region and pass the reference or pointer to the target. The target receives the reference or pointer, and based on the reference or pointer pointing to the first memory region, the target instantiates the object in the first memory region. When the comparison does not indicate to instantiate the object in the first memory region and/or when the comparison indicates to instantiate the object in the second memory region, the system selects the second memory region for the target to instantiate the object (Operation 798). The system may generate a reference or pointer to the second memory region and pass the reference or pointer to the target. The target receives the reference or pointer, and based on the reference or pointer pointing to the second memory region, the target instantiates the object in the second memory region.

In one example, the comparison indicates to instantiate the object in a first memory region when the bitwise AND operation returns a value that is non-zero. In one example, the first memory region is a shared memory region, and the bitwise AND operation returns a non-zero value when the caller and the target of the call have a shared object-generating relationship. Additionally, or alternatively, the comparison may indicate to instantiate the object in a second memory region when the bitwise AND operation returns a value that is zero. In one example, the second memory region is a private memory region, such as a thread-local memory region, and the bitwise AND operation returns a value of zero when the caller and the target of the call have a private object-generating relationship.

### 7. Example Embodiments

The present disclosure is further described by the following example embodiments by way of example and not by way of limitation. The following example embodiments refer to the following callers and targets described with reference to FIGS. 5A-5G and FIGS. 6A-6C: caller (X1), caller (Y1), caller (Y2), caller (Z1), target (R2), target (S1), target (S2), target (S3), and target (T1). Additionally, following example embodiments refer to calling relationships represented by various combinations of the aforementioned callers and targets as described with reference to FIGS. 5A-5G and FIGS. 6A-6C. Other example embodiments will be apparent, including by way of extension of the example embodiment that follow to other scenarios, such as other combinations of callers, targets, and calling relationships.

### 7.1. Utilizing the Same Bit Position of a Memory Allocation Bitmask for Different Calling Relationships

In one example, a system utilizes the same bit position of a memory allocation bitmask for determining a memory region for instantiating objects in response to calls corresponding to different calling relationships. The system may utilize the same bit position of the memory allocation bitmask for calling relationships that are not linked to one another by a memory allocation constraint.

The system defines a set of memory allocation constraints for calls from a set of caller methods to a set of target methods. The calls from the set of caller methods to the set of target methods represent calling relationships that include shared object-generating relationships and/or private object-generating relationships. The set of memory allocation constraints may include a first memory allocation constraint that requires a first target method (R2) and a second target method (S2) to utilize different memory regions from one another for instantiating objects in response to calls from a first caller method (X1). The calls from the first caller method to the first target method may represent a shared object-generating relationship. The calls from the first caller method to the second target method may represent a private object-generating relationship. Additionally, or alternatively, the set of memory allocation constraints may include a second memory allocation constraint that requires the second target method (S2) and a third target method (S1) to utilize different memory regions from one another for instantiating objects in response to calls from a second caller method (Y1). The calls from the second caller method to the second target method may represent a private object-generating relationship. The calls from the second caller method to the third target method may represent a shared object-generating relationship.

In one example, the system determines the first memory allocation constraint based at least in part on a first constraint input and a second constraint input. The first constraint input may include an indication that calls from the first caller method (X1) to the first target method (R2) are capable of triggering the first target method (R2) to instantiate one or more shared objects. Additionally, or alternatively, the first constraint input may indicate that a first calling relationship that includes the first caller method and the first target method is a shared object-generating relationship. The second constraint input may include an indication that calls from the first caller method (X1) to the second target method (S2) have yet to trigger the second target method (S2) to instantiate one or more shared objects. Additionally, or alternatively, the second constraint input may indicate that a second calling relationship that includes the first caller and the second target method is a private object-generating relationship.

In one example, the system determines the second memory allocation constraint based at least in part on a third constraint input and a fourth constraint input. The third constraint input may include an indication that calls from the second caller method (Y1) to the second target method (S2) have yet to trigger the second target method (S2) to instantiate one or more shared objects. Additionally, or alternatively, the third constraint input may indicate that a third calling relationship that includes the second caller method and the second target method is a private object-generating relationship. The fourth constraint input may include an indication that calls from the second caller method (Y1) to the third target method (S1) are capable of triggering the third target method (S1) to instantiate one or more shared objects. Additionally, or alternatively, the fourth constraint input may indicate that a fourth calling relationship that includes the second caller method and the third target method is a shared object-generating relationship.

The system executes a process for configuring a memory allocation bitmask for designating memory regions for instantiating objects in accordance with the set of memory allocation constraints. In one example, the process for configuring the memory allocation bitmask may include determining that the set of memory allocation constraints do not require a set of calling relationships to utilize different memory regions for instantiating objects. Additionally, when the set of memory allocation constraints do not require the set of calling relationships to utilize different memory regions for instantiating objects, the process includes utilizing the same bit position of the memory allocation bitmask for indicating a memory region to be utilized for the set of calling relationships. In one example, the system determines, based at least on the first memory allocation constraint and the second memory allocation constraint, that the set of memory allocation constraints does not require utilization of different memory regions for instantiating objects as between (a) calls from the first caller method (X1) to the first target method (R2) and (b) calls from the second caller method (Y1) to the third target method (S1). The system designates a first memory allocation bit position of the memory allocation bitmask for indicating that a first memory region is to be utilized for instantiating objects in response to (a) calls from the first caller method (X1) to the first target method (R2) and (b) calls from the second caller method (Y1) to the third target method (S1). The system may instantiate a first object in the first memory region in response to a first call from the first caller method (X1) to the first target method (R2). Additionally, or alternatively, the system may instantiate a second object in the first memory region in response to a second call from the second caller method (Y1) to the third target method (S1).

In one example, the process for configuring the memory allocation bitmask may include determining that the set of memory allocation constraints require a set of calling relationships to utilize different memory regions for instantiating objects. Additionally, when the set of memory allocation constraints require the set of calling relationships to utilize different memory regions for instantiating objects, the process includes utilizing different bit positions of the memory allocation bitmask for indicating that different memory regions are to be utilized for the set of calling relationships. In one example, the system determines, based at least on the second memory allocation constraint, that the set of memory allocation constraints require utilization of different memory regions for instantiating objects as between (a) calls from the second caller method (Y1) to the second target method (S2) and (b) calls from the second caller method (Y1) to the third target method (S1). The system designates a second memory allocation bit position of the memory allocation bitmask for indicating that a second memory region is to be utilized for instantiating objects in response to calls from the second caller method (Y1) to the second target method (S2). The system may instantiate a third object in the second memory region in response to a third call from the second caller method (Y1) to the second target method (S2).

In one example, designating the first memory allocation bit position of the memory allocation bitmask includes designating a first target bit position of a first target bitmask and designating a first caller bit position of a first caller bitmask. The system generates the first target bitmask in association with the first target method (R2). Based at least on the first memory allocation constraint, the system designates the first target bit position of the first target bitmask for indicating whether the first memory region is to be utilized for instantiating objects in response to calls to the first target method (R2). Additionally, the system generates the first caller bitmask in association with the first caller method (X1). Based at least on the first target bitmask, the system designates the first caller bit position of the first caller bitmask for indicating whether the first memory region is to be utilized for instantiating objects in response to calls from the first caller method (X1). The system stores the first target bitmask for comparison to the memory allocation bitmask in response to calls to the first target method (R2). The system stores the first caller bitmask for populating the memory allocation bitmask with the first caller bitmask for calls from the first caller method (X1). When the system detects a call from the first caller method, the system populates the memory allocation bitmask with the first caller bitmask. The first caller bit position populates to the first memory allocation bit position.

In one example, the system detects a first call from the first caller method (X1) to the first target method (R2). The first call includes an instruction to instantiate a first object. Responsive at least in part to the first call, the system populates the memory allocation bitmask with the first caller bitmask based at least on the first call being from the first caller method (X1). Additionally, based at least on the first call being to the first target method (R2), the system selects the first target bitmask associated with the first target method (R2) and executes a comparison of the memory allocation bitmask to the first target bitmask. The comparison includes executing a bitwise operation on the memory allocation bitmask and the first target bitmask to obtain a bitwise result. In one example, the bitwise operation is a bitwise AND operation. In one example, the bitwise result is non-zero. The non-zero bitwise result indicates for the system to designate the first memory region for the first target method (R2) to instantiate the first object. Based at least on the bitwise result, the system designates the first memory region for instantiating the first object. The first target method (R2) instantiates the first object in the first memory region. In one example, the first memory region is a shared memory region.

In one example, designating the first memory allocation bit position of the memory allocation bitmask includes designating a first target bit position of a second target bitmask and designating a first caller bit position of a second caller bitmask. The system generates the second target bitmask in association with the third target method (S1). Based at least on the second memory allocation constraint, the system designates the first target bit position of the second target bitmask for indicating whether the first memory region is to be utilized for instantiating objects in response to calls to the third target method (S1). Additionally, the system generates the second caller bitmask in association with the second caller method (Y1). Based at least on the second target bitmask, the system designates the first caller bit position of the second caller bitmask for indicating whether the first memory region is to be utilized for instantiating objects in response to calls from the second caller method (Y1). The system stores the second target bitmask for comparison to the memory allocation bitmask in response to calls to the third target method (S1). The system stores the second caller bitmask for populating the memory allocation bitmask with the second caller bitmask for calls from the second caller method (Y1). When the system detects a call from the second caller method, the system populates the memory allocation bitmask with the second caller bitmask. The first caller bit position of the second caller bitmask populates to the first memory allocation bit position.

In one example, the system detects a second call from the second caller method (Y1) to the third target method (S1). The second call includes an instruction to instantiate a second object. Responsive at least in part to the second call, the system populates the memory allocation bitmask with the second caller bitmask based at least on the second call being from the second caller method (Y1). Additionally, based at least on the second call being to the third target method (S1), the system selects the second target bitmask associated with the third target method (S1) and executes a comparison of the memory allocation bitmask to the second target bitmask. The comparison includes executing a bitwise operation on the memory allocation bitmask and the second target bitmask to obtain a bitwise result. In one example, the bitwise operation is a bitwise AND operation. In one example, the bitwise result is non-zero. The non-zero bitwise result indicates for the system to designate the first memory region for the third target method (S1) to instantiate the first object. Based at least on the bitwise result, the system designates the first memory region for instantiating the first object. The third target method (S1) instantiates the second object in the first memory region. In one example, the first memory region is a shared memory region.

In one example, the system detects a third call from the first caller method (X1) to the second target method (S2). The third call includes an instruction to instantiate a third object. Responsive at least in part to the third call, the system populates the memory allocation bitmask with the first caller bitmask based at least on the third call being from the first caller method (X1). Additionally, based at least on the third call being to the second target method (S2), the system selects the second target bitmask associated with the second target method (S2) and executes a comparison of the memory allocation bitmask to the second target bitmask. The comparison includes executing a bitwise operation on the memory allocation bitmask and the second target bitmask to obtain a bitwise result. In one example, the bitwise operation is a bitwise AND operation. In one example, the bitwise result is zero. The zero bitwise result indicates for the system to designate a second memory region for the second target method (S2) to instantiate the third object. Based at least on the bitwise result, the system designates the second memory region for instantiating the thirds object. The second target method (S2) instantiates the third object in the second memory region. In one example, the second memory region is a private memory region, such as a thread-local memory region.

### 7.2. Utilizing Different Bit Positions of a Memory Allocation Bitmask for Different Calling Relationships

In one example, the system utilizes different bit positions of the memory allocation bitmask for determining memory regions for instantiating objects in response to calls corresponding to different calling relationships. The system may utilize different bit positions for calling relationships that are linked to one another by a memory allocation constraint.

The system further defines the set of memory allocation constraints. The set of memory allocation constraints may include a third memory allocation constraint that requires the third target method (S1) and a fourth target method (S3) to utilize different memory regions from one another for instantiating objects in response to calls from a third caller method (Y2). The calls from the third caller method to the third target method may represent a private object-generating relationship. The calls from the third caller method to the fourth target method may represent a shared object-generating relationship. Additionally, or alternatively, the set of memory allocation constraints may include a fourth memory allocation constraint that requires the second target method (S2) and the fourth target method (S3) to utilize different memory regions from one another for instantiating objects in response to calls from a fourth caller method (Z1). The calls from the fourth caller method to the second target method may represent a private object-generating relationship. The calls from the fourth caller method to the fourth target method may represent a shared object-generating relationship. Additionally, or alternatively, the set of memory allocation constraints may include a fifth memory allocation constraint that requires the second target method (S2) and the third target method (S1) to utilize different memory regions from one another for instantiating objects in response to calls from the third caller method (Y2). The calls from the third caller method to the second target method may represent a shared object-generating relationship. The calls from the third caller method to the third target method may represent a private object-generating relationship.

The system executes a process for configuring a memory allocation bitmask for designating memory regions for instantiating objects in accordance with the set of memory allocation constraints. In one example, the process for configuring the memory allocation bitmask may include determining that the set of memory allocation constraints require a set of calling relationships to utilize different memory regions for instantiating objects and utilizing different bit position of the memory allocation bitmask for indicating a memory region to be utilized for the set of calling relationships.

In one example, the system determines, based on the set of memory allocation constraints, that the set of memory allocation constraints requires utilization of different memory regions for instantiating objects as between (a) calls from the third caller method (Y2) to the third target method (S1) and (b) calls from the third caller method (Y2) to the fourth target method (S3). The system designates a second memory allocation bit position of the memory allocation bitmask for indicating that the first memory region is to be utilized for instantiating objects in response to calls from the third caller method (Y2) to the second target method (S2). Additionally, the system designates a third memory allocation bit position of the memory allocation bitmask for indicating that the first memory region is to be utilized for instantiating objects in response to calls from the third caller method (Y2) to the fourth target method (S3).

In one example, designating the second memory allocation bit position of the memory allocation bitmask includes designating a second target bit position of a second target bitmask and designating a second caller bit position of the second caller bitmask. The system generates the second target bitmask in association with the second target method (S2). Based on the set of memory allocation constraints, the system designates the second target bit position of the second target bitmask for indicating whether the first memory region is to be utilized for instantiating objects in response to calls to the second target method (S2). Additionally, the system generates the second caller bitmask in association with the third caller method (Y2). Based at least on the second target bitmask, the system designates the second caller bit position of the second caller bitmask for indicating whether the first memory region is to be utilized for instantiating objects in response to calls from the third caller method (Y2) to the second target method (S2).

In one example, designating the third memory allocation bit position of the memory allocation bitmask includes designating a third target bit position of a third target bitmask and designating a third caller bit position of the third caller bitmask. The system generates the third target bitmask in association with the fourth target method (S3). Based on the set of memory allocation constraints, the system designates a third target bit position of the third target bitmask for indicating whether the first memory region is to be utilized for instantiating objects in response to calls to the fourth target method (S3). Additionally, based at least on the third target bitmask, the system designates a third caller bit position of the second caller bitmask for indicating whether the first memory region is to be utilized for instantiating objects in response to calls from the third caller method (Y2) to the fourth target method (S3). The second caller bit position of the second caller bitmask and the third caller bit position of the second caller bitmask are located at a different bit sequence index relative to one another.

The system stores the second target bitmask for comparison to the memory allocation bitmask in response to calls to the third target method (S1). The system stores the third target bitmask for comparison to the memory allocation bitmask in response to calls to the fourth target method (S3). The system stores the second caller bitmask for populating the memory allocation bitmask with the second caller bitmask for calls from the third caller method (Y2). When the system detects a call from the third caller method, the system populates the memory allocation bitmask with the second caller bitmask. The second caller bit position populates to the second memory allocation bit position. The third caller bit position populates to the third memory allocation bit position.

In one example, the system detects a third call from the third caller method (Y2) to the second target method (S2). The third call includes an instruction to instantiate a third object. Responsive at least in part to the third call, the system populates the memory allocation bitmask with the second caller bitmask based at least on the third call being from the third caller method (Y2). Additionally, based at least on the third call being to the second target method (S2), the system selects the second target bitmask associated with the second target method (S2) and executes a comparison of the memory allocation bitmask to the second target bitmask. The comparison includes executing a bitwise operation on the memory allocation bitmask and the second target bitmask to obtain a bitwise result. In one example, the bitwise operation is a bitwise AND operation. In one example, the bitwise result is non-zero. The non-zero bitwise result indicates for the system to designate the first memory region for the second target method (S2) to instantiate the third object. Based at least on the bitwise result, the system designates the first memory region for instantiating the third object. The second target method (S2) instantiates the third object in the first memory region. In one example, the first memory region is a shared memory region.

In one example, the system detects a fourth call from the third caller method (Y2) to the fourth target method (S3). The fourth call includes an instruction to instantiate a fourth object. Responsive at least in part to the fourth call, the system populates the memory allocation bitmask with the second caller bitmask based at least on the fourth call being from the third caller method (Y2). Additionally, based at least on the fourth call being to the fourth target method (S3), the system selects the third target bitmask associated with the fourth target method (S3) and executes a comparison of the memory allocation bitmask to the third target bitmask. The comparison includes executing a bitwise operation on the memory allocation bitmask and the third target bitmask to obtain a bitwise result. In one example, the bitwise operation is a bitwise AND operation. In one example, the bitwise result is non-zero. The non-zero bitwise result indicates for the system to designate the first memory region for the fourth target method (S3) to instantiate the fourth object. Based at least on the bitwise result, the system designates the first memory region for instantiating the fourth object. The fourth target method (S3) instantiates the fourth object in the first memory region. In one example, the first memory region is a shared memory region.

In one example, the system detects a fifth call from the third caller method (Y2) to the third target method (S1). The fifth call includes an instruction to instantiate a fifth object. Responsive at least in part to the fifth call, the system populates the memory allocation bitmask with the second caller bitmask based at least on the fifth call being from the third caller method (Y2). Additionally, based at least on the fifth call being to the third target method (S1), the system selects a fourth target bitmask associated with the third target method (S1) and executes a bitwise operation on the memory allocation bitmask and the fourth target bitmask to obtain a bitwise result. In one example, the bitwise operation is a bitwise AND operation. In one example, the bitwise result is zero. The zero bitwise result indicates for the system to designate the second memory region for the third target method (S1) to instantiate the fifth object. Based at least on the bitwise result, the system designates the second memory region for instantiating the fifth object. The third target method (S1) instantiates the fifth object in the second memory region. In one example, the second memory region is a private memory region such as a thread-local memory region.

### 7.3. Memory Allocation Constraints Based on Allocation Sites Executed by Target Methods

In one example, the system defines a set of one or more memory allocation constraints based on allocation sites that are executed by target methods. In one example, the system defines a third memory allocation constraint that requires a first allocation site of the first target method (R2) and a second allocation site of the second target method (S2) to utilize different memory regions from one another for instantiating objects in response to calls from the first caller method (X1). Additionally, or alternatively, the system defines a fourth memory allocation constraint that requires the second allocation site of the second target method (S2) and a third allocation site of the third target method (S1) to utilize different memory regions from one another for instantiating objects in response to calls from the second caller method (Y1).

The system executes a process for configuring a memory allocation bitmask for designating memory regions for instantiating objects in accordance with the set of memory allocation constraints. In one example, the system determines, based at least on the third memory allocation constraint and the fourth memory allocation constraint, that the set of memory allocation constraints does not require utilization of different memory regions for instantiating objects as between (a) calls from the first caller method (X1) to the first target method that execute the first allocation site of the first target method (R2) and (b) calls from the second caller method (Y1) to the third target method that execute the third allocation site of the third target method (S1). The system designates a second memory allocation bit position of the memory allocation bitmask for indicating that a first memory region is to be utilized for instantiating objects in response to (a) calls from the first caller method (X1) to the first target method that execute the first allocation site of the first target method (R2) and (b) calls from the second caller method (Y1) to the third target method that execute the third allocation site of the third target method (S1). The first target method executes the first allocation site of the first target method (R2) to instantiate a third object in the first memory region in response to a third call from the first caller method (X1). The third target method executes the third allocation site of the third target method (S1) to instantiate a fourth object in the first memory region in response to a fourth call from the second caller method (Y1).

7.4. Memory Allocation Constraints Based on Caller Sites that Call Target Methods

In one example, the system defines a set of one or more memory allocation constraints based on caller sites that call target methods. In one example, the system defines a third memory allocation constraint that requires the first target method (R2) and the second target method (S2) to utilize different memory regions from one another for instantiating objects in response to calls from a first caller site of the first caller method (X1). Additionally, or alternatively, the system defines a fourth memory allocation constraint that requires the second target method (S2) and the third target method (S1) to utilize different memory regions from one another for instantiating objects in response to calls from a second caller site of the second caller method (Y1).

The system executes a process for configuring a memory allocation bitmask for designating memory regions for instantiating objects in accordance with the set of memory allocation constraints. In one example, the system determines, based at least on the third memory allocation constraint and the fourth memory allocation constraint, that the set of memory allocation constraints does not require utilization of different memory regions for instantiating objects as between (a) calls from the first caller site of the first caller method (X1) to the first target method (R2) and (b) calls from the second caller site of the second caller method (Y1) to the third target method (S1). The system designates a second memory allocation bit position of the memory allocation bitmask for indicating that the first memory region is to be utilized for instantiating objects in response to (a) calls from the first caller site of the first caller method (X1) to the first target method (R2) and (b) calls from the second caller site of the second caller method (Y1) to the third target method (S1). The first target method (R2) instantiates a third object in the first memory region in response to a third call from the first caller site of the first caller method (X1) to the first target method (R2). The third target method (S1) instantiates a fourth object in the first memory region in response to a fourth call from the second caller site of the second caller method (Y1).

7.5. Memory Allocation Constraints Based on Allocation Sites Executed by Target Methods in Response to Calls from Caller Sites of Caller Methods

In one example, the system defines a set of one or more memory allocation constraints based on allocation sites that are executed by target methods in response to calls from caller sites of caller methods. In one example, the system defines a third memory allocation constraint that requires a first allocation site of the first target method (R2) and a second allocation site of the second target method (S2) to utilize different memory regions from one another for instantiating objects in response to calls from a first caller site of the first caller method (X1). Additionally, or alternatively, the system defines a fourth memory allocation constraint that requires the second allocation site of the second target method (S2) and a third allocation site of the third target method (S1) to utilize different memory regions from one another for instantiating objects in response to calls from a second caller site of the second caller method (Y1).

The system executes a process for configuring a memory allocation bitmask for designating memory regions for instantiating objects in accordance with the set of memory allocation constraints. In one example, the system determines, based at least on the third memory allocation constraint and the fourth memory allocation constraint, that the set of memory allocation constraints does not require utilization of different memory regions for instantiating objects as between (a) calls from the first caller site of the first caller method (X1) to the first target method that execute the first allocation site of the first target method (R2) and (b) calls from the second caller site of the second caller method (Y1) to the third target method that execute the third allocation site of the third target method (S1). The system designates a second memory allocation bit position of the memory allocation bitmask for indicating that the first memory region is to be utilized for instantiating objects in response to (a) calls from the first caller site of the first caller method (X1) to the first target method that execute the first allocation site of the first target method (R2) and (b) calls from the second caller site of the second caller method (Y1) to the third target method that execute the third allocation site of the third target method (S1). The first target method executes the first allocation site of the first target method (R2) to instantiate a third object in the first memory region in response to a third call from the first caller site of the first caller method (X1). The third target method executes the third allocation site of the third target method (S1) to instantiate a fourth object in the first memory region in response to a fourth call from the second caller site of the second caller method (Y1).

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

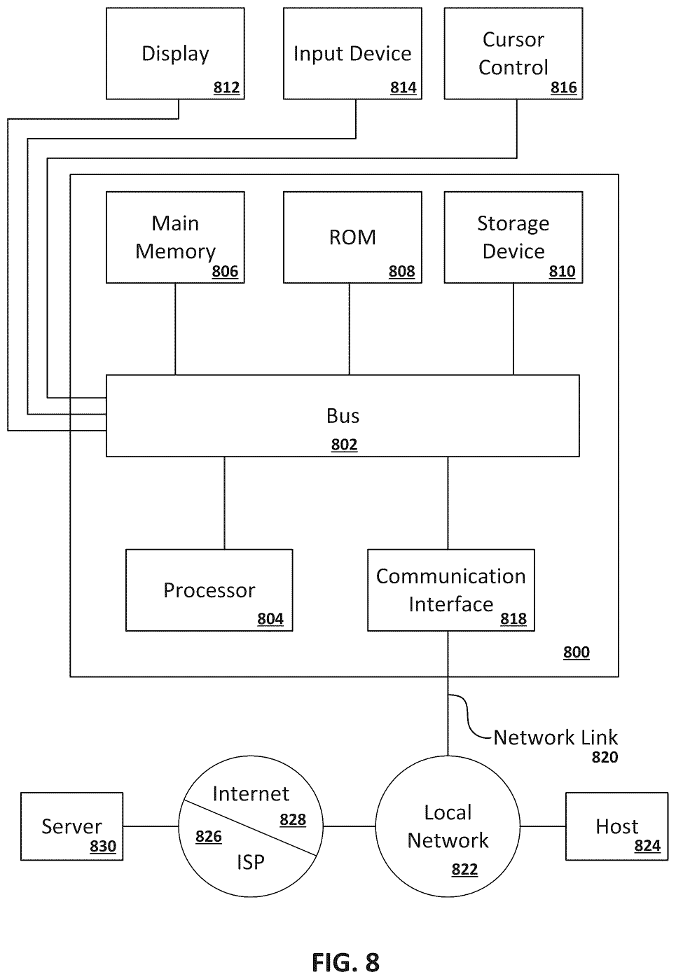

For example, FIG. 8 is a block diagram that illustrates a computer system 800 that may be utilized to implement at least one embodiment of the present disclosure. Computer system 800 may include a bus 802 or other communication mechanism for communicating information, and a hardware processor 804 coupled with bus 802 for processing information. Hardware processor 804 may be, for example, a general-purpose microprocessor.

Computer system 800 also may include a main memory 806, such as a random-access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 may further include a read only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic that, in combination with the computer system, causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media may include, for example, optical or magnetic disks, such as storage device 810. Volatile media may include dynamic memory, such as main memory 806. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media may include coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806. Processor 804 retrieves the data from main memory 806 and executes the instructions. The instructions received from main memory 806 may optionally be stored on storage device 810 either before or after execution by processor 804.

Computer system 800 also may include a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic, or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world-wide packet data communication network now commonly referred to as the “Internet” 828. Local network 822 and Internet 828 both use electrical, electromagnetic, or optical signals that carry digital data streams. Example forms of transmission media include the signals through the various networks, the signals through network link 820, and the signals through communication interface 818.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818. The received code may be executed by processor 804 as it is received, and/or stored in storage device 810, or other non-volatile storage for later execution.

### 9. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions that, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of patent protection, and what is intended by the applicants to be the scope of patent protection, is the literal and equivalent scope of the set of claims that issue from this application, in the specific form that such claims issue, including any subsequent correction.

What is claimed is:

1. A method, comprising:
defining a set of memory allocation constraints for calls from a set of caller methods to a set of target methods, wherein defining the set of memory allocation constraints comprises:
defining a first memory allocation constraint that requires a first target method and a second target method to utilize different memory regions from one another for instantiating objects in response to calls from a first caller method, and
defining a second memory allocation constraint that requires the second target method and a third target method to utilize different memory regions from one another for instantiating objects in response to calls from a second caller method;
executing a process for configuring a memory allocation bitmask for designating memory regions for instantiating objects in accordance with the set of memory allocation constraints, wherein the process comprises:
determining, based at least on the first memory allocation constraint and the second memory allocation constraint, that the set of memory allocation constraints does not require utilization of different memory regions for instantiating objects as between (a) calls from the first caller method to the first target method and (b) calls from the second caller method to the third target method, and
designating a first memory allocation bit position of the memory allocation bitmask for indicating that a first memory region is to be utilized for instantiating objects in response to (a) calls from the first caller method to the first target method and (b) calls from the second caller method to the third target method,
wherein a first object is instantiated in the first memory region in response to a first call from the first caller method to the first target method, and wherein a second object is instantiated in the first memory region in response to a second call from the second caller method to the third target method;
wherein the method is performed by at least one device including a hardware processor.

2. The method of claim 1, further comprising:
prior to defining the first memory allocation constraint:
determining a first constraint input comprising one or more calls from the first caller method to the first target method being capable of triggering the first target method to instantiate one or more shared objects, and
determining a second constraint input comprising one or more calls from the first caller method to the second target method having yet to trigger the second target method to instantiate one or more shared objects; and
defining the first memory allocation constraint based at least on the first constraint input and the second constraint input.

3. The method of claim 1, wherein executing the process for configuring the memory allocation bitmask for designating memory regions for instantiating objects in accordance with the set of memory allocation constraints further comprises:
designating, based at least on the second memory allocation constraint, a second memory allocation bit position of the memory allocation bitmask for indicating that a second memory region is to be utilized for instantiating objects in response to calls from the second caller method to the second target method,
wherein a third object is instantiated in the second memory region in response to a third call from the second caller method to the second target method.

4. The method of claim 3, further comprising:
prior to defining the second memory allocation constraint:
determining a third constraint input comprising one or more calls from the second caller method to the second target method having yet to trigger the second target method to instantiate one or more shared objects, and
determining a fourth constraint input comprising one or more calls from the second caller method to the third target method being capable of triggering the third target method to instantiate one or more shared objects; and
defining the second memory allocation constraint based at least on the third constraint input and the fourth constraint input.

5. The method of claim 1, wherein designating the first memory allocation bit position of the memory allocation bitmask comprises:
generating a first target bitmask in association with the first target method;
designating, based at least on the first memory allocation constraint, a first target bit position of the first target bitmask for indicating whether the first memory region is to be utilized for instantiating objects in response to calls to the first target method;
generating a first caller bitmask in association with the first caller method;
designating, based at least on the first target bitmask, a first caller bit position of the first caller bitmask for indicating whether the first memory region is to be utilized for instantiating objects in response to calls from the first caller method; and
populating the memory allocation bitmask with the first caller bitmask for calls from the first caller method, wherein the first caller bit position populates to the first memory allocation bit position.

6. The method of claim 5, further comprising:
detecting the first call from the first caller method to the first target method, wherein the first call comprises an instruction to instantiate the first object, and responsive at least in part to the first call:
based at least on the first call being from the first caller method, populating the memory allocation bitmask with the first caller bitmask;
based at least on the first call being to the first target method, selecting the first target bitmask associated with the first target method and executing a bitwise operation on the memory allocation bitmask and the first target bitmask to obtain a bitwise result;
based at least on the bitwise result, designating the first memory region for instantiating the first object;
instantiating the first object in the first memory region.

7. The method of claim 5, further comprising:
detecting a third call from the first caller method to the second target method, wherein the third call comprises an instruction to instantiate a third object, and responsive at least in part to the third call:
based at least on the third call being from the first caller method, populating the memory allocation bitmask with the first caller bitmask,
based at least on the third call being to the second target method, selecting a second target bitmask associated with the second target method and executing a bitwise operation on the memory allocation bitmask and the second target bitmask to obtain a bitwise result,
based at least on the bitwise result, designating a thread-local memory region for instantiating the third object, and
instantiating the third object in the thread-local memory region.

8. The method of claim 5, wherein designating the first memory allocation bit position of the memory allocation bitmask further comprises:
generating a second target bitmask in association with the third target method;
designating, based at least on the second memory allocation constraint, a first target bit position of the second target bitmask for indicating whether the first memory region is to be utilized for instantiating objects in response to calls to the third target method;
designating, based at least on the second target bitmask, the first caller bit position of a second caller bitmask for indicating whether the first memory region is to be utilized for instantiating objects in response to calls from the second caller method; and
populating the memory allocation bitmask with the second caller bitmask for calls from the second caller method,
wherein the first caller bit position of the second caller bitmask populates to the first memory allocation bit position of the memory allocation bitmask,
wherein the first caller bit position of the first caller bitmask and the first caller bit position of the second caller bitmask are located at a same bit sequence index relative to one another.

9. The method of claim 1,
wherein defining the set of memory allocation constraints further comprises:
defining a third memory allocation constraint that requires the third target method and a fourth target method to utilize different memory regions from one another for instantiating objects in response to calls from a third caller method, and
defining a fourth memory allocation constraint that requires the second target method and the fourth target method to utilize different memory regions from one another for instantiating objects in response to calls from a fourth caller method;
wherein executing the process for configuring the memory allocation bitmask for designating memory regions for instantiating objects in accordance with the set of memory allocation constraints further comprises:
determining that the set of memory allocation constraints requires utilization of different memory regions for instantiating objects as between (a) calls from the third caller method to the third target method and (b) calls from the third caller method to the fourth target method, and
designating a second memory allocation bit position of the memory allocation bitmask for indicating that the first memory region is to be utilized for instantiating objects in response to calls from the third caller method to the second target method,
designating a third memory allocation bit position of the memory allocation bitmask for indicating that the first memory region is to be utilized for instantiating objects in response to calls from the third caller method to the fourth target method,
wherein a third object is instantiated in the first memory region in response to a third call from the third caller method to the second target method, and wherein a fourth object is instantiated in the first memory region in response to a fourth call from the third caller method to the fourth target method.

10. The method of claim 9, wherein defining the set of memory allocation constraints further comprises:
defining a fifth memory allocation constraint that requires the second target method and the third target method to utilize different memory regions from one another for instantiating objects in response to calls from the third caller method.

11. The method of claim 9,
wherein designating the second memory allocation bit position of the memory allocation bitmask comprises:
generating a second target bitmask in association with the second target method;
designating, based on the set of memory allocation constraints, a second target bit position of the second target bitmask for indicating whether the first memory region is to be utilized for instantiating objects in response to calls to the second target method;
generating a second caller bitmask in association with the third caller method;
designating, based at least on the second target bitmask, a second caller bit position of the second caller bitmask for indicating whether the first memory region is to be utilized for instantiating objects in response to calls from the third caller method to the second target method; and
wherein designating the third memory allocation bit position of the memory allocation bitmask comprises:
generating a third target bitmask in association with the fourth target method;
designating, based on the set of memory allocation constraints, a third target bit position of the third target bitmask for indicating whether the first memory region is to be utilized for instantiating objects in response to calls to the fourth target method;
designating, based at least on the third target bitmask, a third caller bit position of the second caller bitmask for indicating whether the first memory region is to be utilized for instantiating objects in response to calls from the third caller method to the fourth target method; and
populating the memory allocation bitmask with the second caller bitmask for calls from the third caller method, wherein the second caller bit position populates to the second memory allocation bit position, wherein the third caller bit position populates to the third memory allocation bit position,
wherein the second caller bit position of the second caller bitmask and the third caller bit position of the second caller bitmask are located at a different bit sequence index relative to one another.

12. The method of claim 11, further comprising at least one of:
(a) detecting the third call from the third caller method to the second target method, wherein the third call comprises a first instruction to instantiate the third object, and responsive at least in part to the third call:
based at least on the third call being from the third caller method, populating the memory allocation bitmask with the second caller bitmask,
based at least on the third call being to the second target method, selecting the second target bitmask associated with the second target method and executing a first bitwise operation on the memory allocation bitmask and the second target bitmask to obtain a first bitwise result,
based at least on the first bitwise result, designating a second memory region for instantiating the third object, and
instantiating the third object in the second memory region; or
(b) detecting the fourth call from the third caller method to the fourth target method, wherein the fourth call comprises a second instruction to instantiate the fourth object, and responsive at least in part to the fourth call:
based at least on the fourth call being from the third caller method, populating the memory allocation bitmask with the second caller bitmask,
based at least on the fourth call being to the fourth target method, selecting the third target bitmask associated with the fourth target method and executing a second bitwise operation on the memory allocation bitmask and the third target bitmask to obtain a second bitwise result,
based at least on the second bitwise result, designating the first memory region for instantiating the fourth object, and
instantiating the fourth object in the first memory region.

13. The method of claim 11, further comprising:
detecting a fifth call from the third caller method to the third target method, wherein the fifth call comprises an instruction to instantiate a fifth object, and responsive at least in part to the fifth call;
based at least on the fifth call being from the third caller method, populating the memory allocation bitmask with the second caller bitmask,
based at least on the fifth call being to the third target method, selecting a fourth target bitmask associated with the third target method and executing a bitwise operation on the memory allocation bitmask and the fourth target bitmask to obtain a bitwise result,
based at least on the bitwise result, designating a thread-local memory region for instantiating the fifth object, and
instantiating the fifth object in the thread-local memory region.

14. The method of claim 1,
wherein defining the set of memory allocation constraints further comprises:
defining a third memory allocation constraint that requires a first allocation site of the first target method and a second allocation site of the second target method to utilize different memory regions from one another for instantiating objects in response to calls from the first caller method, and
defining a fourth memory allocation constraint that requires the second allocation site of the second target method and a third allocation site of the third target method to utilize different memory regions from one another for instantiating objects in response to calls from the second caller method;
wherein executing the process for configuring the memory allocation bitmask for designating memory regions for instantiating objects in accordance with the set of memory allocation constraints further comprises:
determining, based at least on the third memory allocation constraint and the fourth memory allocation constraint, that the set of memory allocation constraints does not require utilization of different memory regions for instantiating objects as between (a) calls from the first caller method to the first target method that execute the first allocation site of the first target method and (b) calls from the second caller method to the third target method that execute the third allocation site of the third target method, and
designating a second memory allocation bit position of the memory allocation bitmask for indicating that the first memory region is to be utilized for instantiating objects in response to (a) calls from the first caller method to the first target method that execute the first allocation site of the first target method and (b) calls from the second caller method to the third target method that execute the third allocation site of the third target method;
wherein a third object is instantiated in the first memory region in response to a third call from the first caller method to the first target method that executes the first allocation site of the first target method, and wherein a fourth object is instantiated in the first memory region in response to a fourth call from the second caller method to the third target method that executes the third allocation site of the third target method.

15. The method of claim 1,
wherein defining the set of memory allocation constraints further comprises:
defining a third memory allocation constraint that requires the first target method and the second target method to utilize different memory regions from one another for instantiating objects in response to calls from a first caller site of the first caller method, and
defining a fourth memory allocation constraint that requires the second target method and the third target method to utilize different memory regions from one another for instantiating objects in response to calls from a second caller site of the second caller method;
wherein executing the process for configuring the memory allocation bitmask for designating memory regions for instantiating objects in accordance with the set of memory allocation constraints further comprises:
determining, based at least on the third memory allocation constraint and the fourth memory allocation constraint, that the set of memory allocation constraints does not require utilization of different memory regions for instantiating objects as between (a) calls from the first caller site of the first caller method to the first target method and (b) calls from the second caller site of the second caller method to the third target method, and
designating a second memory allocation bit position of the memory allocation bitmask for indicating that the first memory region is to be utilized for instantiating objects in response to (a) calls from the first caller site of the first caller method to the first target method and (b) calls from the second caller site of the second caller method to the third target method;
wherein a third object is instantiated in the first memory region in response to a third call from the first caller site of the first caller method to the first target method, and wherein a fourth object is instantiated in the first memory region in response to a fourth call from the second caller site of the second caller method to the third target method.

16. The method of claim 1,
wherein defining the set of memory allocation constraints further comprises:
defining a third memory allocation constraint that requires a first allocation site of the first target method and a second allocation site of the second target method to utilize different memory regions from one another for instantiating objects in response to calls from a first caller site of the first caller method, and
defining a fourth memory allocation constraint that requires the second allocation site of the second target method and a third allocation site of the third target method to utilize different memory regions from one another for instantiating objects in response to calls from a second caller site of the second caller method;
wherein executing the process for configuring the memory allocation bitmask for designating memory regions for instantiating objects in accordance with the set of memory allocation constraints further comprises:
determining, based at least on the third memory allocation constraint and the fourth memory allocation constraint, that the set of memory allocation constraints does not require utilization of different memory regions for instantiating objects as between (a) calls from the first caller site of the first caller method to the first target method that execute the first allocation site of the first target method and (b) calls from the second caller site of the second caller method to the third target method that execute the third allocation site of the third target method, and
designating a second memory allocation bit position of the memory allocation bitmask for indicating that the first memory region is to be utilized for instantiating objects in response to (a) calls from the first caller site of the first caller method to the first target method that execute the first allocation site of the first target method and (b) calls from the second caller site of the second caller method to the third target method that execute the third allocation site of the third target method;
wherein a third object is instantiated in the first memory region in response to a third call from the first caller site of the first caller method to the first target method that executes the first allocation site of the first target method, and wherein a fourth object is instantiated in the first memory region in response to a fourth call from the second caller site of the second caller method to the third target method that executes the third allocation site of the third target method.

17. The method of claim 1, wherein the first memory region is a shared memory region.

18. The method of claim 17, wherein a third object is instantiated in a thread-local memory region in response to a third call from the first caller method to the second target method, or wherein a fourth object is instantiated in the thread-local memory region in response to a fourth call from the second caller method to the second target method.

19. One or more non-transitory computer-readable media comprising instructions that, when executed by one or more hardware processors, cause performance of operations comprising:
defining a set of memory allocation constraints for calls from a set of caller methods to a set of target methods, wherein defining the set of memory allocation constraints comprises:
defining a first memory allocation constraint that requires a first target method and a second target method to utilize different memory regions from one another for instantiating objects in response to calls from a first caller method, and
defining a second memory allocation constraint that requires the second target method and a third target method to utilize different memory regions from one another for instantiating objects in response to calls from a second caller method;
executing a process for configuring a memory allocation bitmask for designating memory regions for instantiating objects in accordance with the set of memory allocation constraints, wherein the process comprises:
determining, based at least on the first memory allocation constraint and the second memory allocation constraint, that the set of memory allocation constraints does not require utilization of different memory regions for instantiating objects as between (a) calls from the first caller method to the first target method and (b) calls from the second caller method to the third target method, and
designating a first memory allocation bit position of the memory allocation bitmask for indicating that a first memory region is to be utilized for instantiating objects in response to (a) calls from the first caller method to the first target method and (b) calls from the second caller method to the third target method,
wherein a first object is instantiated in the first memory region in response to a first call from the first caller method to the first target method, and wherein a second object is instantiated in the first memory region in response to a second call from the second caller method to the third target method.

20. A system comprising:
at least one device including a hardware processor;
the system being configured to perform operations comprising:
defining a set of memory allocation constraints for calls from a set of caller methods to a set of target methods, wherein defining the set of memory allocation constraints comprises:
defining a first memory allocation constraint that requires a first target method and a second target method to utilize different memory regions from one another for instantiating objects in response to calls from a first caller method, and
defining a second memory allocation constraint that requires the second target method and a third target method to utilize different memory regions from one another for instantiating objects in response to calls from a second caller method;
executing a process for configuring a memory allocation bitmask for designating memory regions for instantiating objects in accordance with the set of memory allocation constraints, wherein the process comprises:
determining, based at least on the first memory allocation constraint and the second memory allocation constraint, that the set of memory allocation constraints does not require utilization of different memory regions for instantiating objects as between (a) calls from the first caller method to the first target method and (b) calls from the second caller method to the third target method, and
designating a first memory allocation bit position of the memory allocation bitmask for indicating that a first memory region is to be utilized for instantiating objects in response to (a) calls from the first caller method to the first target method and (b) calls from the second caller method to the third target method,
wherein a first object is instantiated in the first memory region in response to a first call from the first caller method to the first target method, and wherein a second object is instantiated in the first memory region in response to a second call from the second caller method to the third target method.
